(19) United States
(12) Patent Application Publication
(10) Pub. No.: US 2002/0049853 A1
(43) Pub. Date: Apr. 25, 2002

(54) End-to-end secure file transfer method and system

(76) Inventors: Tan-Na Chu, Locust Valley, NY (US); Philip D. Cotty, Glen Head, NY (US); Yao H. Chu, Locust Valley, NY (US); David D. Sun, Ithaca, NY (US)

Correspondence Address: Brian P. Hopkins, Mintz, Levin, Cohn, Ferris, Glovsky and Popeo, P.C, One Financial Center, Boston, MA, 02111, US

(21) Appl. No.: 09/930,812

(22) Filed: Aug. 16, 2001

Related U.S. Application Data
(60) Provisional application No. 60/225,715, filed on Aug. 16, 2000.
(60) Provisional application No. 60/226,749, filed on Aug. 21, 2000.

(51) Int. Cl. G06F 15/16; G06F 11/30; H04L 9/32; G06F 12/14

(52) U.S. Cl. 709/237; 709/229; 713/200

(57) ABSTRACT

A secure electronic file transfer system and methods of its use are provided. The sender issues a request to the DAD (Digital Asset Distribution) system causing files residing on local or remote computers to be transferred to the recipient via application and TCP/IP protocols. Client software may be automatically downloaded and installed to the sending and/or receiving device to facilitate the packaging and transfer of said file to a DAD server, and said file may optionally be propagated from said DAD server to additional DAD servers and other non-DAD servers.

This application claims benefit under 35 U.S.C. §119(e) of the filing dates of U.S. Provisional Application No. 60/225,715, filed Aug. 16, 2000, and U.S. Provisional Application No. 60/226,749, filed Aug. 21, 2000; the entire disclosures of which are incorporated herein by reference.

### BACKGROUND OF THE INVENTION

1. Field Of The Invention

The invention relates to the field of computer networks. More particularly, the invention relates to techniques for the secure delivery of electronic documents between users over the Internet.

2. Background of The Prior Art

Electronic Mail (e-mail) provides a means for sending electronic messages from one computer user to another. E-mail has advantages of convenience, format and storage of messages for later retrieval. As such, e-mail has been accepted and widely used for basic communication. E-mail is typically an ASCII based format, however, and proves to be very limiting for the communication of long or formatted documents. As well, e-mail is not the medium of choice for the distribution of complex documents, such as reports, articles, advertisements and art which can include page layout grids, postscript-formatted objects, multiple fonts with tracking and kerning, graphics, imbedded tables and spreadsheets, and other complicated information.

E-mail systems provide a means for appending an ASCII based e-mail message with an associated file, to be downloaded along with the e-mail message. Most systems that allow the appending of an associated file are designed to allow a single user to send unsecured files to an associate or friend, and neither allow for controlled automated distribution to multiple recipients, nor do they provide advanced accounting, billing or other such features (e.g., receipt notification). E-mail gateways also limit the applicability of attachments, and do not solve the problems of security and receipt notation or acknowledgment.

The disclosed prior art systems and methodologies provide some methods for the delivery of documents, but fail to provide a secure, economical, fast document delivery system. Thus, there is a need for the development of such an electronic document delivery system.

### SUMMARY OF THE INVENTION

Accordingly, it is the object of the present invention to address the needs and concerns of the prior art as outlined above.

In a first aspect of the present invention, a method of securely transferring a file from a first client to a second client includes issuing instructions from the first client to a digital asset distribution (DAD) server for transferring a file from the DAD server to the second client. The first client issues the instructions via a website for accessing the DAD server.

In a further feature of the first aspect, prior to issuing the instructions, the method includes issuing initial instructions for uploading the file from the first client to the DAD server. Upon the first client initially accessing the website, first embedded client software for uploading the file is automatically downloaded to the first client.

In a second aspect of the present invention, a method of transferring a file from a first client to a second client includes issuing first instructions from the first client to register an account with a digital asset distribution (DAD) server via a DAD website for transferring a file the second client. The first client includes a web browser for accessing the website. The method also includes issuing second instructions for uploading the file to the DAD server via the DAD website, where upon the first client initially accessing the website, embedded client software for uploading the file is automatically downloaded to the first client. The method also includes notifying the second client that the file is available for downloading from the DAD web site, connecting the second client to the DAD server via the DAD website for downloading the file and downloading the file. The second client also includes a web browser for accessing the DAD website.

Yet another aspect of the present invention is directed to computer readable media having stored thereon a data structure including a first field comprising data representing account information of a client, a second field comprising data representing package information regarding a file for transfer, a third field comprising address information for an address to transfer a file, a fourth field comprising a server site, a fifth field comprising a server list and a sixth field comprising download and/or upload information of a file.

In yet another aspect of the present invention, a graphical user interface for a first client computer system having a selection device is presented where the graphical user interface includes a user login component for logging a client onto a website for a digital asset distribution (DAD) server, a client browsing component for browsing the internet, a file transfer component for forwarding a file to a second client, a tracking component for retrieving tracking information for tracking the file forwarded to the second client, an address book component storing and retrieving an address of the second client and an account information component for retrieving account information related to the first client and/or the second client.

In still another aspect of the present invention, a system for performing a method of transferring a file from a first client to a second client includes a digital asset distribution (DAD) server accessible over the internet via a DAD website, the DAD server including communication means for communicating data with a client over the internet, a first client for instructing the DAD server to forward a file to a destination address, and a second client having the destination address. The first client issues first instructions for registering an account with the digital asset distribution (DAD) server via the website for transferring a file to the destination address of the second client and the first client includes a web browser for accessing the website. The first client issues second instructions for uploading the file to the DAD server via the DAD website and upon the first client initially accessing the website, embedded client software stored on the DAD server operational for a client to upload the file is automatically downloaded to the first client. The first client uploads the file to the DAD server. The system also includes notifying means for notifying the second client that the file is available for downloading from the DAD server. The second client issues third instructions to the DAD server via the DAD website for downloading the file, where the second client includes a web browser for accessing the DAD website, and the second client downloads the file.

The above aspect of the present invention may also include computer readable media having computer-executable instructions for performing the above methods recited therein.

All of the above aspects will become clearer with reference to the accompanying figures and detailed description of the preferred embodiments that follow.

### BRIEF DESCRIPTION OF THE DRAWINGS

FIG. 1 is a diagram depicting the major components of art exemplary electronic file delivery system involving DAD and other servers.

FIG. 1-A illustrates exemplary DAD System functions.

FIG. 1-B illustrates an exemplary DAD System architecture.

FIG. 2 is a block diagram of an exemplary DAD server database.

FIG. 3 illustrates a general outline of an exemplary interface that may be displayed by the client browser.

FIG. 3-A illustrates server receiving file transfer request and generating the embedded client software.

FIG. 3-B illustrates tracking of recently sent files (this diagram connects to FIGS. 3-B-i through 3-B-4).

FIG. 3-B-1 illustrates easier access to file transfer history through sorting and resorting data records.

FIG. 3-B-2 illustrates accessing file transfer details via clicking the displayed transfer identification link.

FIG. 3-B-3 illustrates accessing file transfer details via the selected link of an entire file transfer history.

FIG. 3-B-4 illustrating accessing file transfer details through searching the file transfer database records.

FIG. 3-C illustrates an exemplary address book, which also includes Add, Modify, Delete, and Select capabilities.

FIG. 3-C-1 illustrates adding recipients to the address book for them to be included in the database.

FIG. 3-C-2 illustrates modifying recipients contact and other information in the address book database.

FIG. 3-C-3 illustrates deleting recipients contact and other information in the address book database.

FIG. 3-D illustrates exemplary DAD system account information, 10 including Add, Modify, and Delete capabilities.

FIG. 3-D-1 illustrates a DAD system administrator, user, or sub-user modifies personal information.

FIG. 3-D-2 illustrates a DAD system administrator displays and modifies sub-user account information.

FIG. 3-D-3 illustrates a DAD system administrator deletes sub-user account from the system database.

FIG. 3-D-4 illustrates a DAD system administrator adds sub-user information and DAD system privilege.

FIG. 3-D-5 depicts an exemplary sub-user account detailed information page as seen by the administrator.

FIG. 4 illustrates an example of the recipient being notified by the DAD server and the ensuing communication with the server.

FIG. 4-1 portrays the process that the DAD system undergoes as a result of visits by the recipients.

FIG. 5 shows a set of programs for the DAD file transfer operation through client-server communication.

FIGS. 6 through 6-3 illustrate a preferred process performed by executing the client send program.

FIGS. 7 through 7-2 illustrates an exemplary process performed by executing the client receive program.

FIG. 8 illustrates a preferred exemplary DAD system server program.

FIGS. 9 through 9-2 describe an exemplary DAD server receiving a file from a sender or from another server.

FIGS. 10 through 10-1 illustrate an exemplary process performed by executing the server send program.

FIGS. 11 through 11-2 illustrate an exemplary process for transferring a file 15 from one DAD server to another DAD server or to an FTP server.

FIG. 12 illustrates an exemplary DAD client monitoring program..

FIG. 13 illustrates an exemplary DAD client receive manager.

### DETAILED DESCRIPTION OF THE PREFERRED EMBODIMENTS

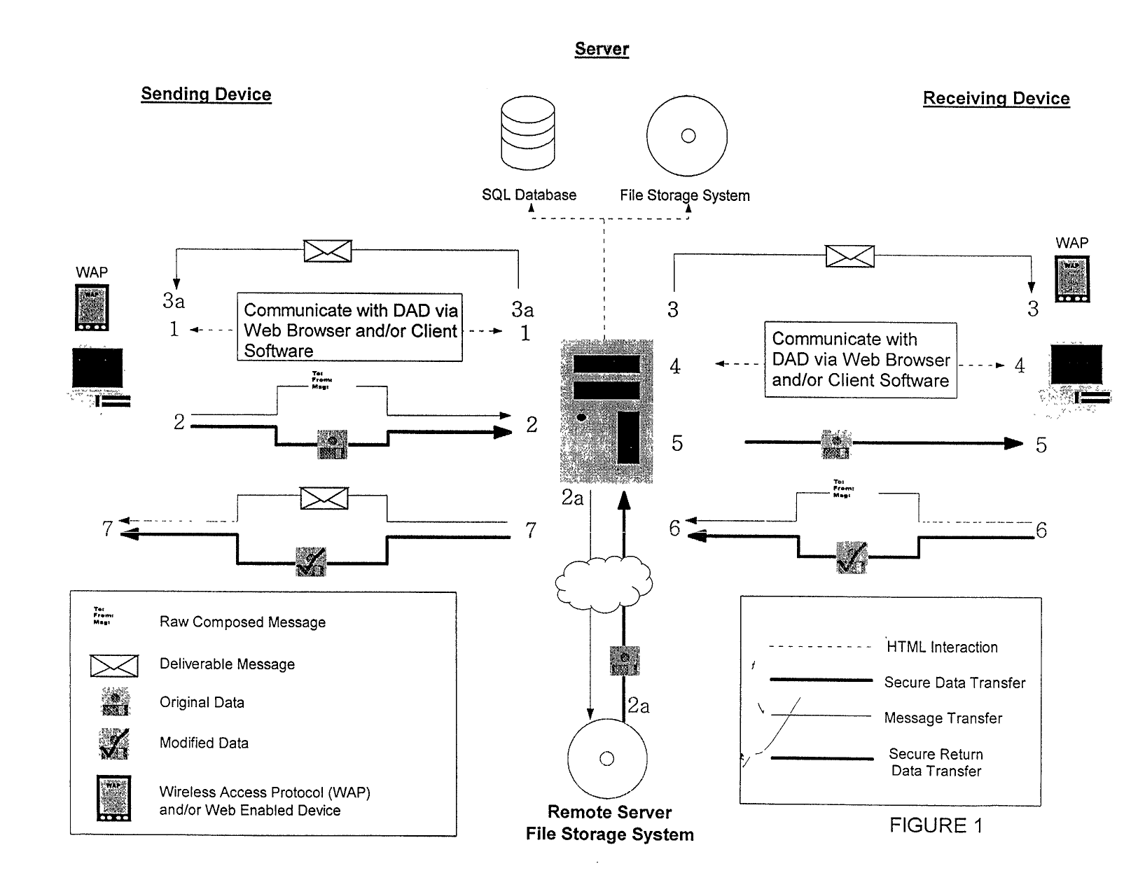

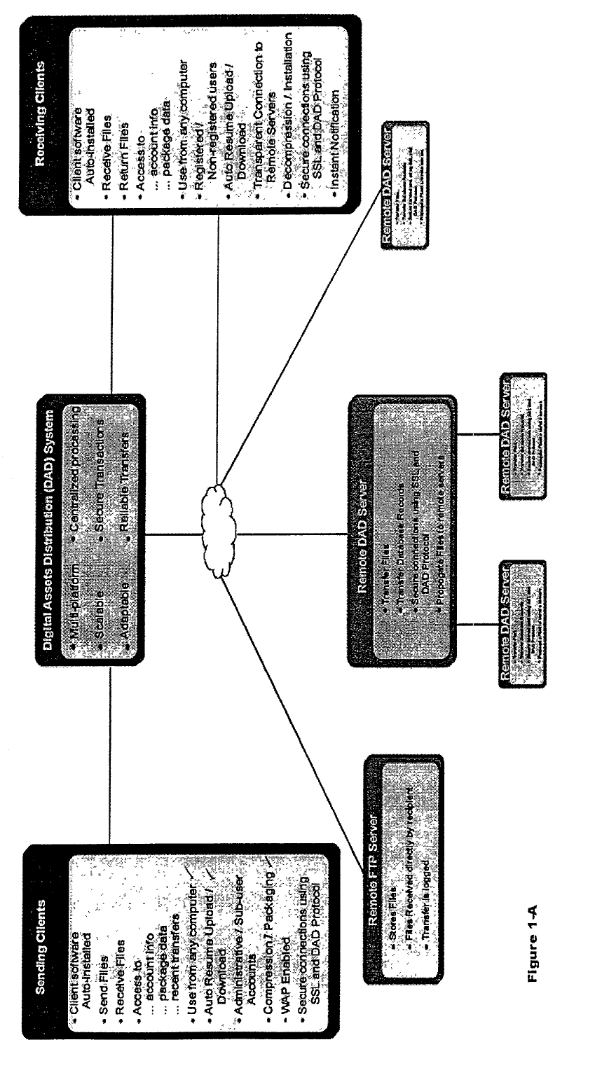

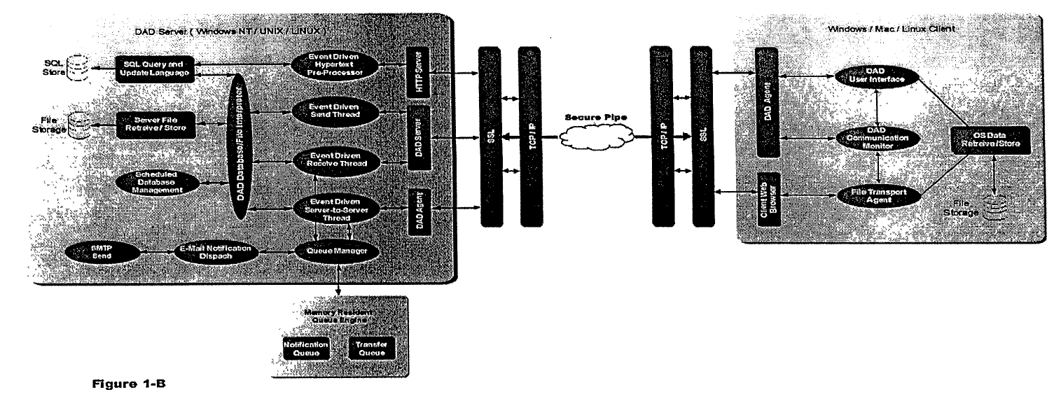

FIG. 1 is a block diagram depicting the major components of an exemplary DAD (digital asset distribution) file transfer system, external servers, and a series of events whereby a sender initiates file transfer by issuing instructions from a sending device (e.g., a device with web browser), to a DAD server causing files to be transferred to the recipient(s). The instructions are sent to the DAD server via a web page, with. the embedded client software automatically downloaded to the sender computer, or via an activating wireless device. If the file to be transferred already resides on the DAD server, the sender issues further instructions for transferring the file to the recipient(s). If the file to be transferred does not yet reside on the DAD server, the sender will use the client software to upload the file from the sender's computer to the DAD server. The sender can also optionally request the first DAD server to forward the file to other DAD server(s) and file server(s) (e.g., FTP servers).

The receiving device can be the recipient(s) computer(s) with web browser. Upon checking the DAD web information page, special e-mail notice, desktop indicator, cell-phone vibratory alert or other types of notification devices, the recipient(s) may access a DAD web page, with the client software automatically downloaded to the recipient(s)' computer(s). The files are then transferred or downloaded to the recipient(s)' computer(s).

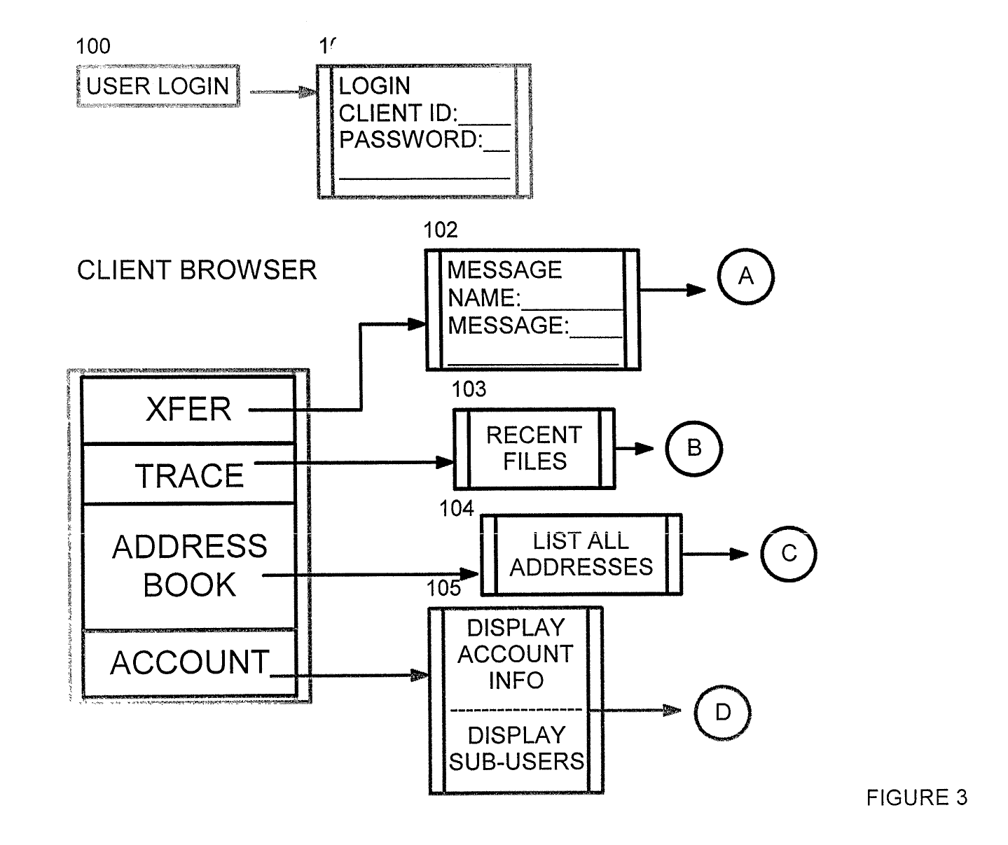

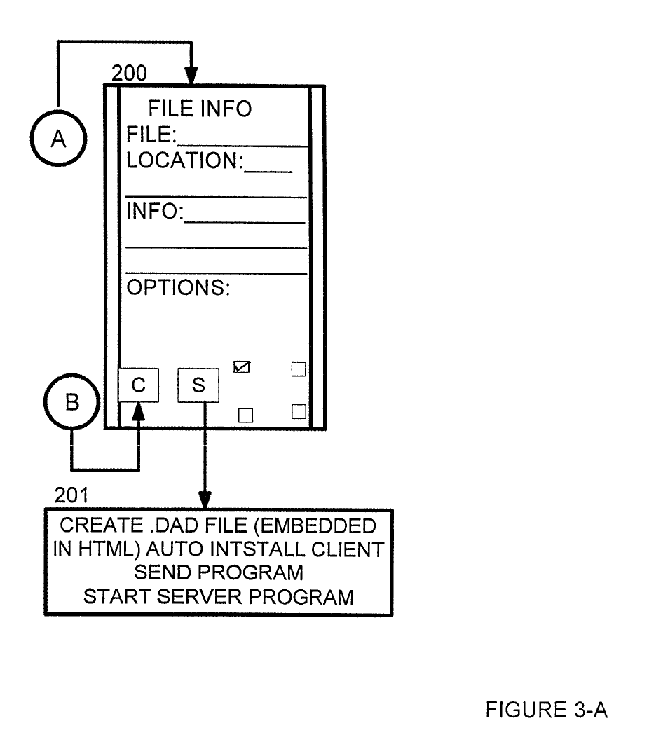

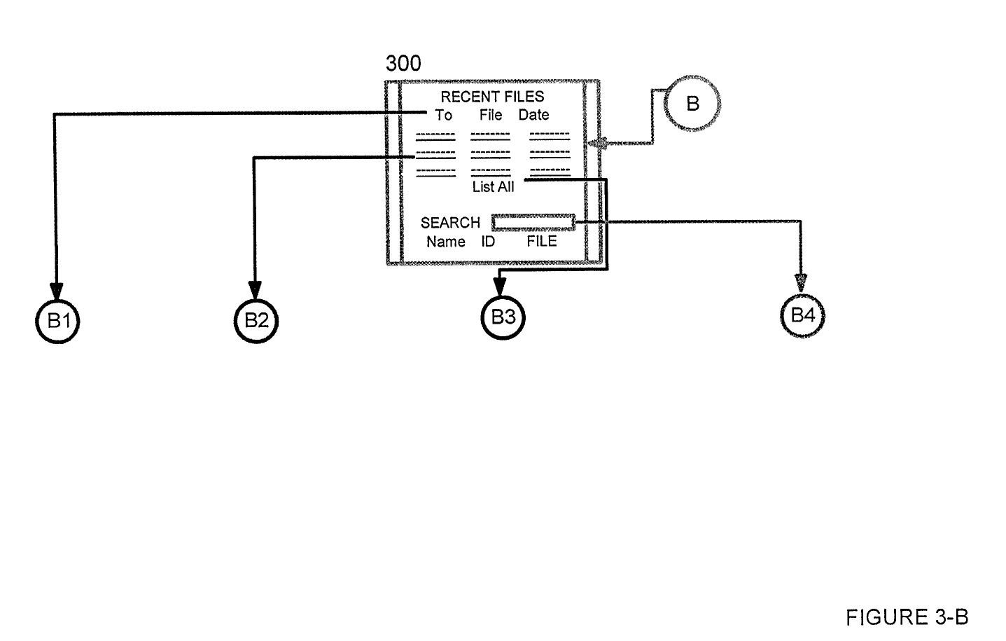

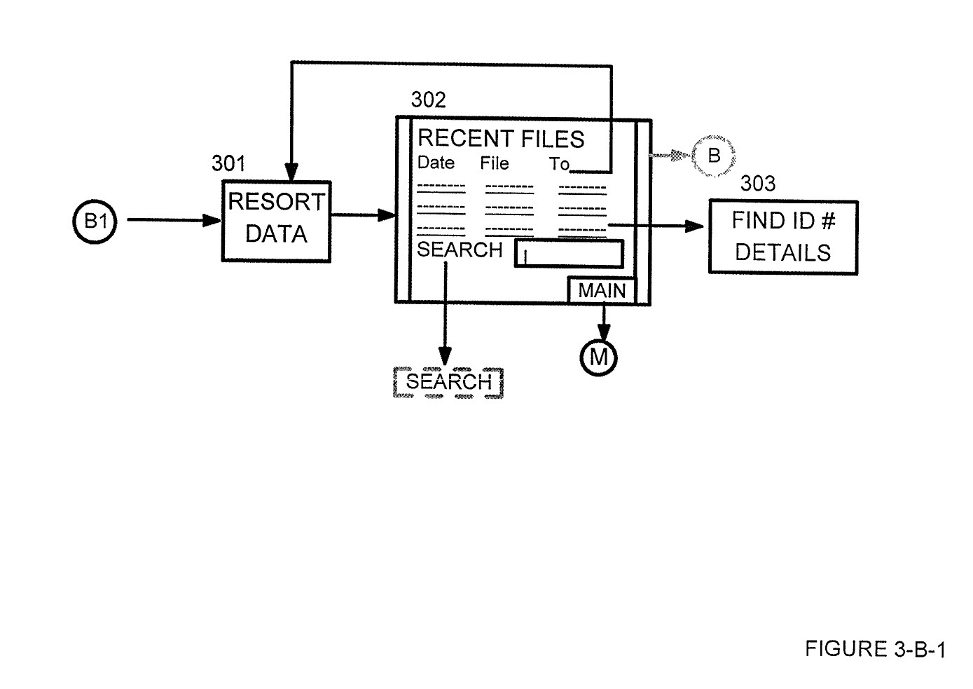

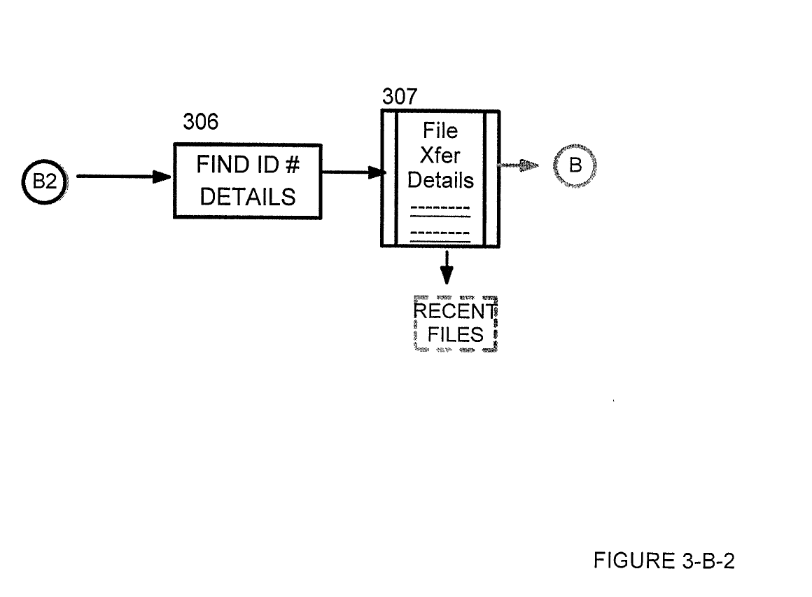

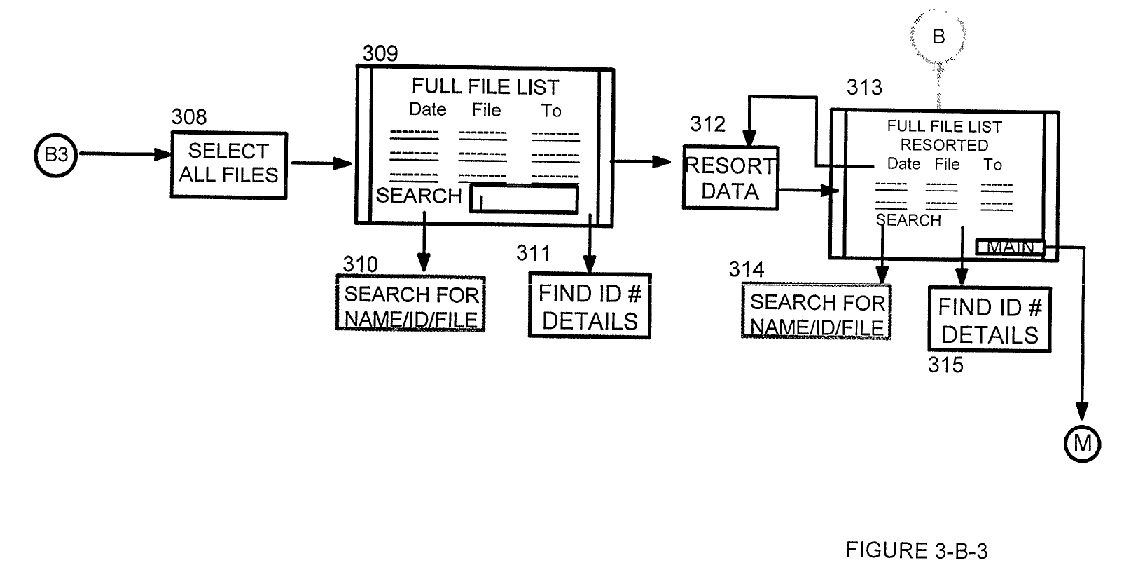

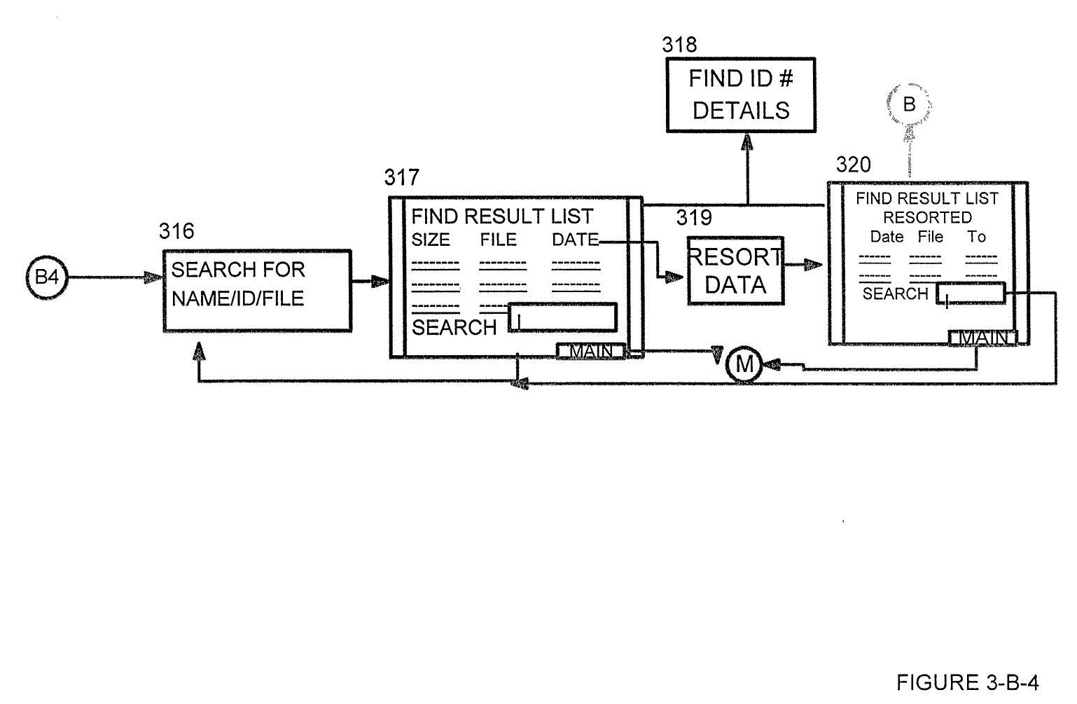

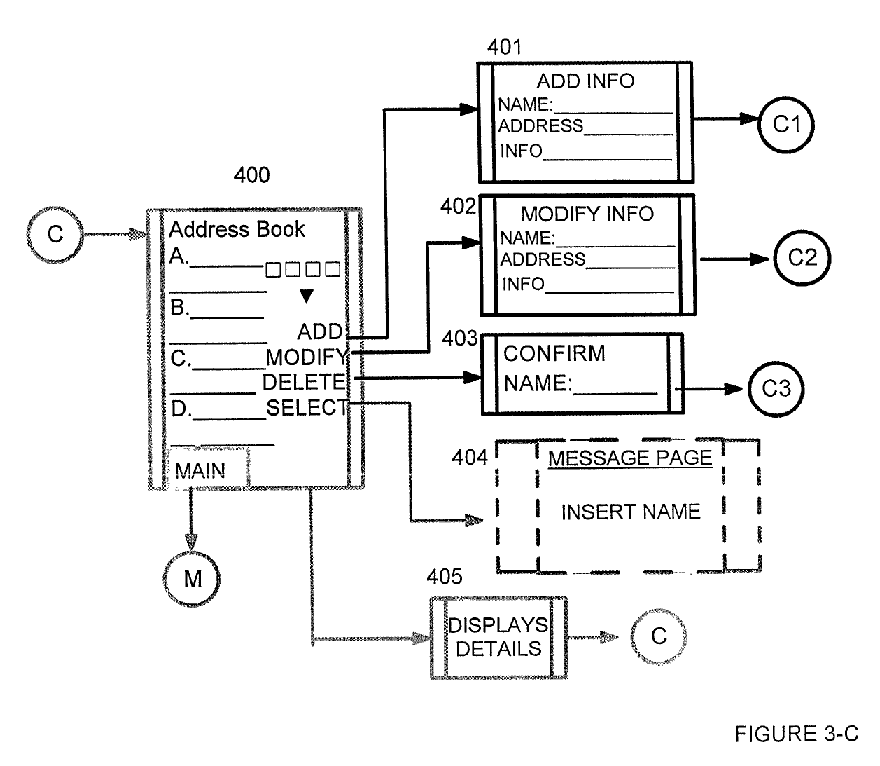

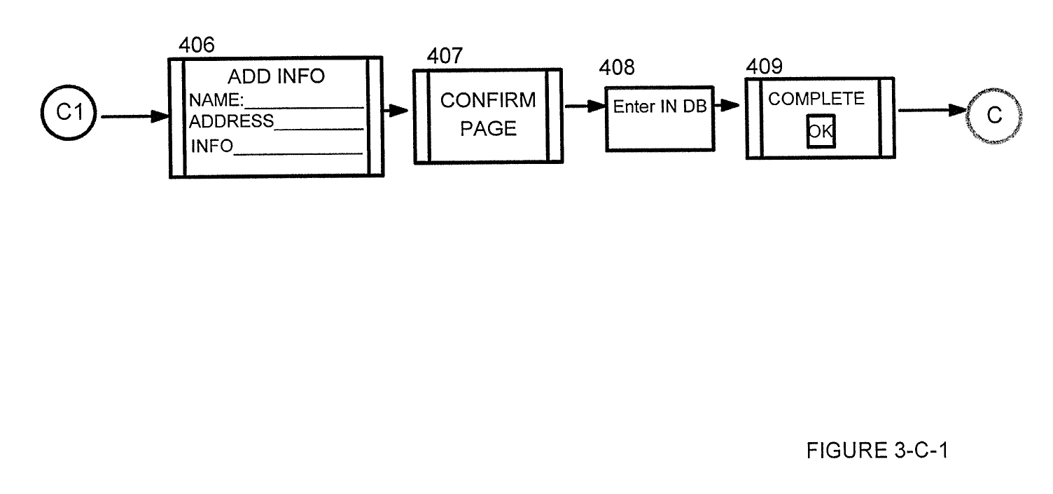

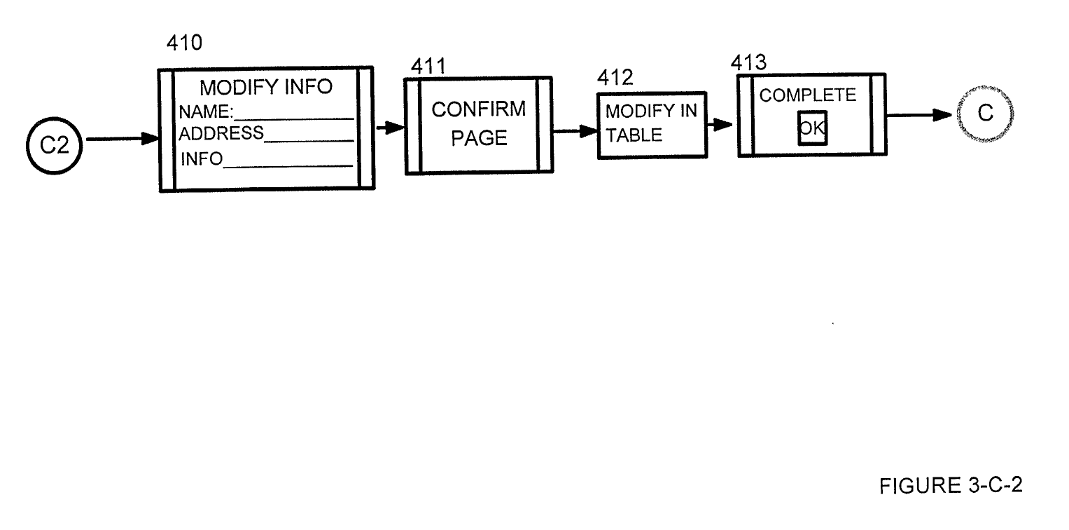

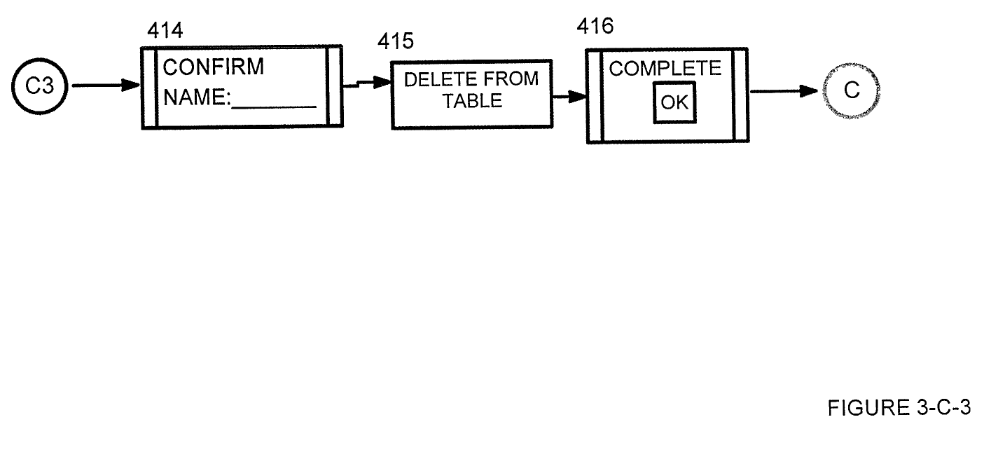

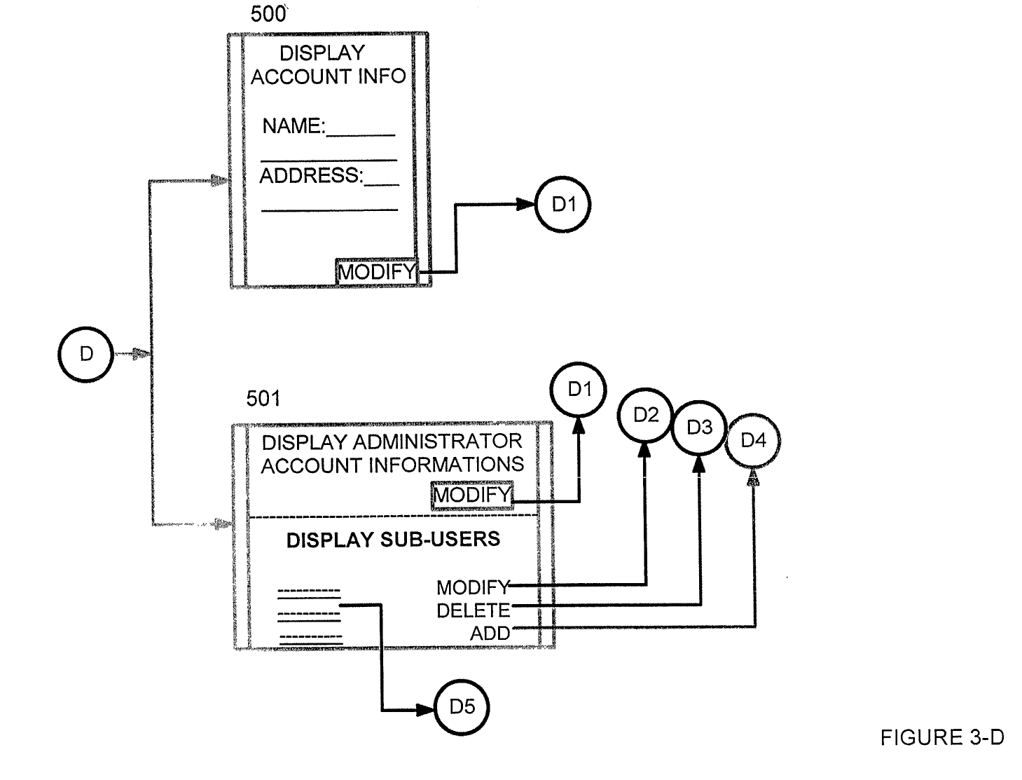

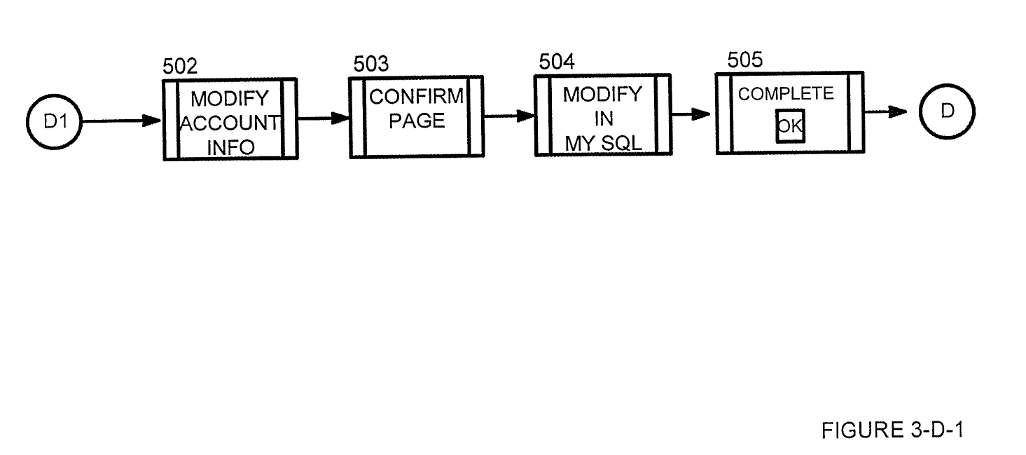

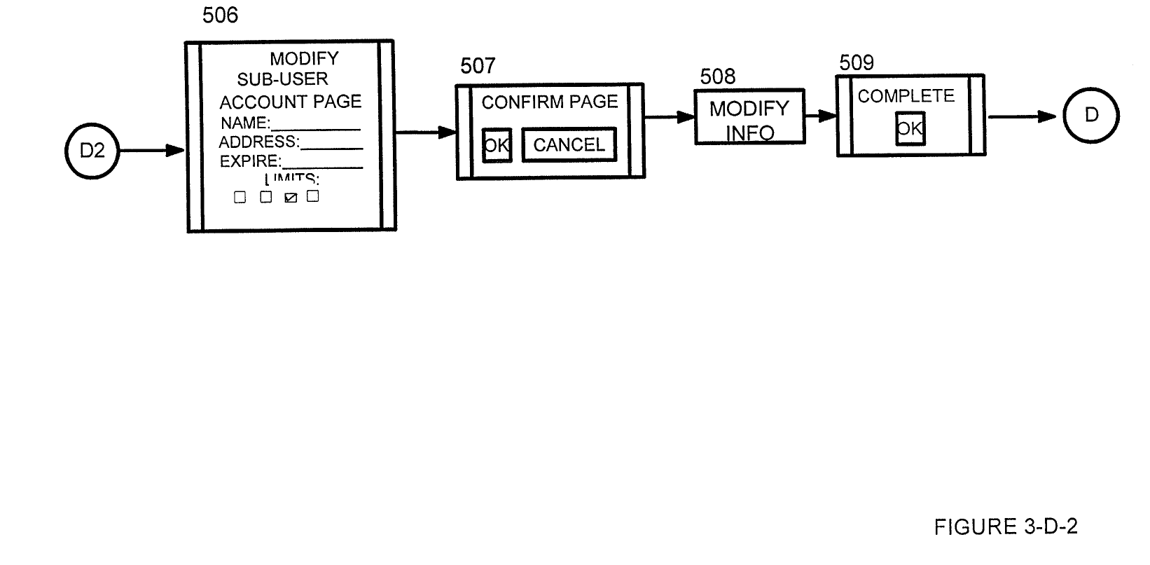

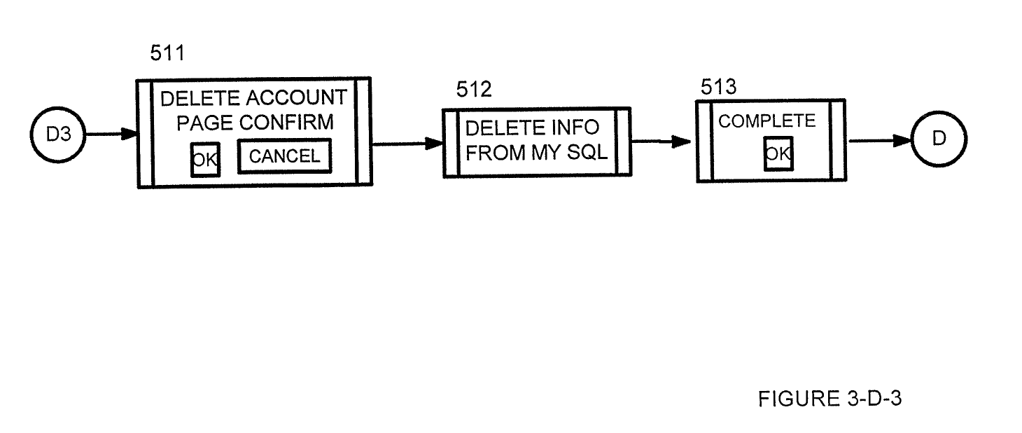

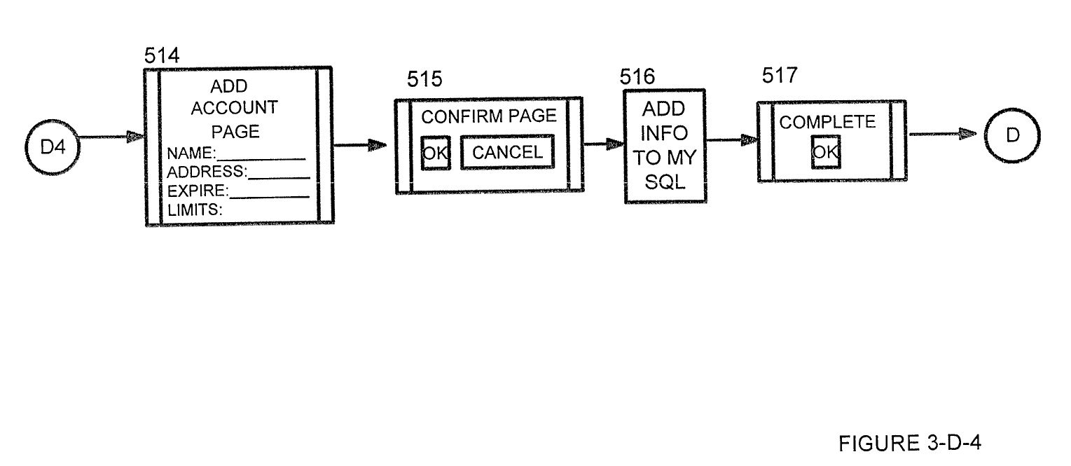

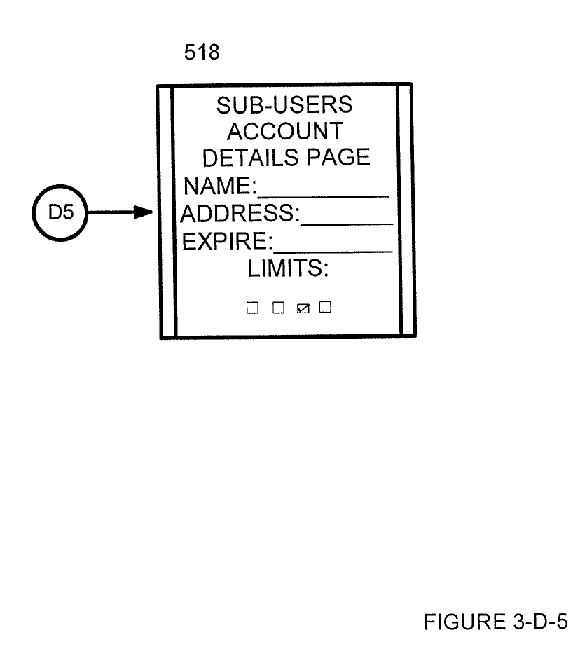

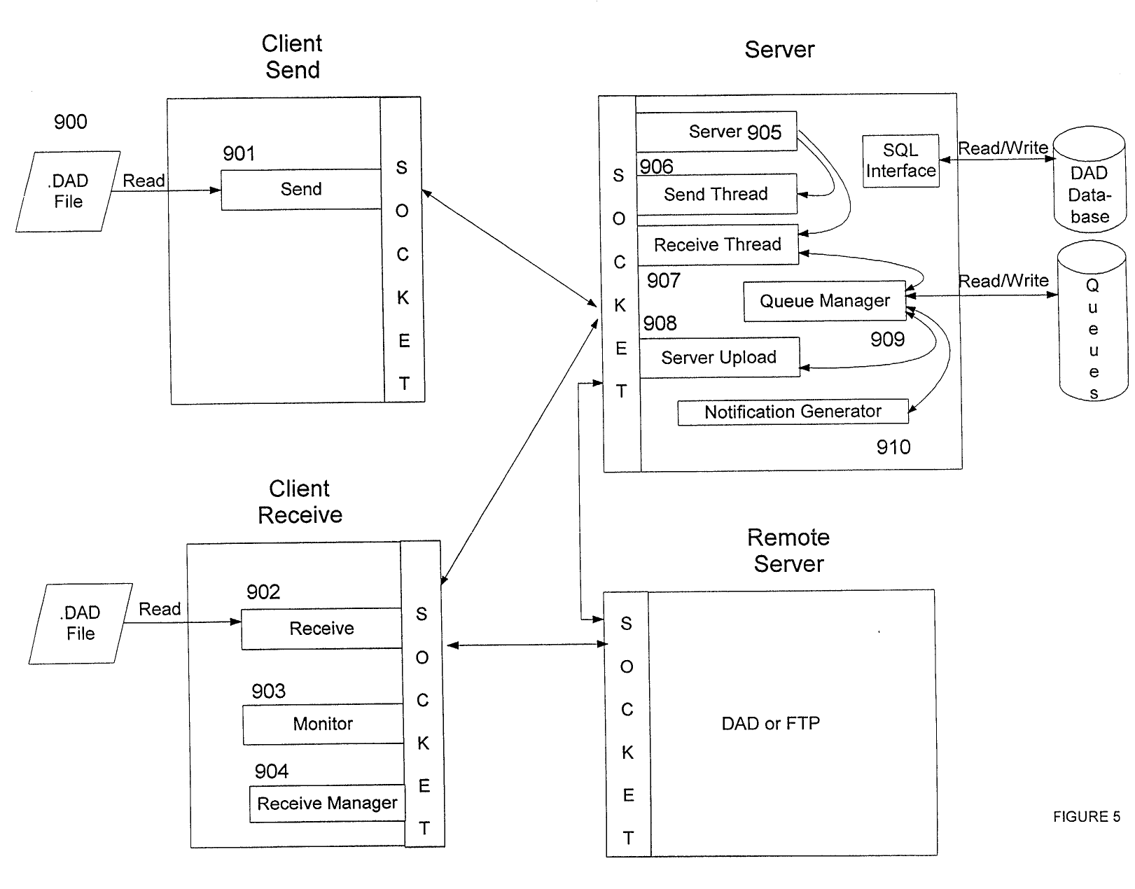

In order for a sender to use the DAD system to send packages, they must be a registered user. In the preferred embodiment, registration may require that the sender input a unique username and password combination, in addition to any required personal information. The sender may also be presented with the option to specify a default file transfer method. If the sender elects to use the web-based interface each time they set up a transfer, it will be required that each time that user wishes to send a package or receive a returned package, they will need to log in to the system via the web, as described in FIGS. 3 and 3-A. If the user elects to use the client software, the client software (client send in 901 of FIG. 5, client receive in 902 of FIG. 5 for receiving the returned package) or an updated version may be automatically downloaded onto their system and installed so that they may use that software each time they wish to send a package or receive a returned package, in lieu of the web-based interface. The sender may receive an e-mail notice of package ID number (PID) from the server to confirm that the package has been successfully registered into the server database.

In the preferred embodiment, registration may require that the recipient input a unique username and password combination, in addition to any required personal information. The recipient may also be presented with the option to specify a default notification and file transfer method. If the recipient elects to use the web-based interface each time they set up a transfer, it will be required that each time that user wishes to receive a package or return a package, they will need to log in to the web page via e-mail link or browser (FIGS. 3, 4 and 4-1). A small receive (902 in FIG. 5) or send (901 in FIG. 5) for returning package program or updates will be automatically downloaded to the recipient's computer via a web page. If the recipients elect to be notified and transfer a file by client software notification, the client software, which may include monitor (903 in FIG. 5), receive manager (904 in FIG. 5), receive programs (902 in FIG. 5), and send program (901 in FIG. 5) for returning package, may be automatically downloaded to or preinstalled on their computer and stay resident in the system, and may routinely connect to the server to determine if that user has received packages. When a package is received, the recipient may be notified by an audio-visual indicator, and may be prompted to download the package at that time.

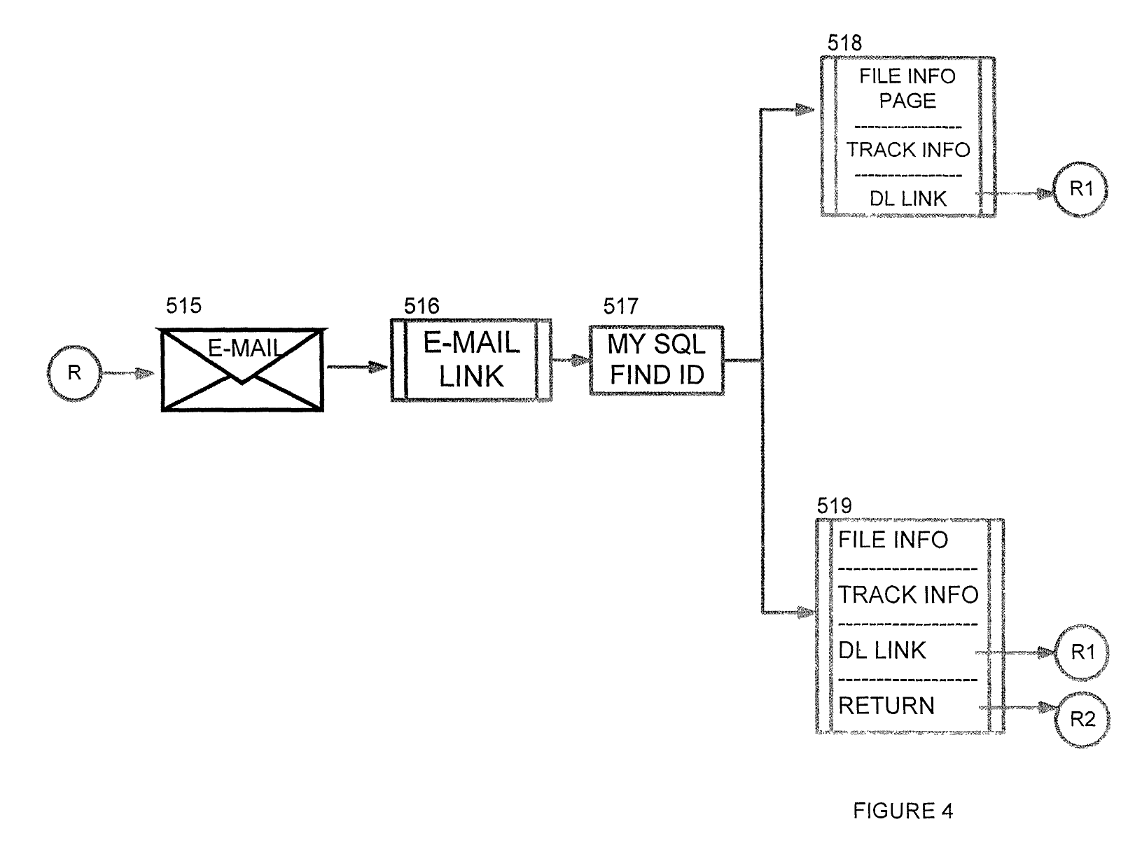

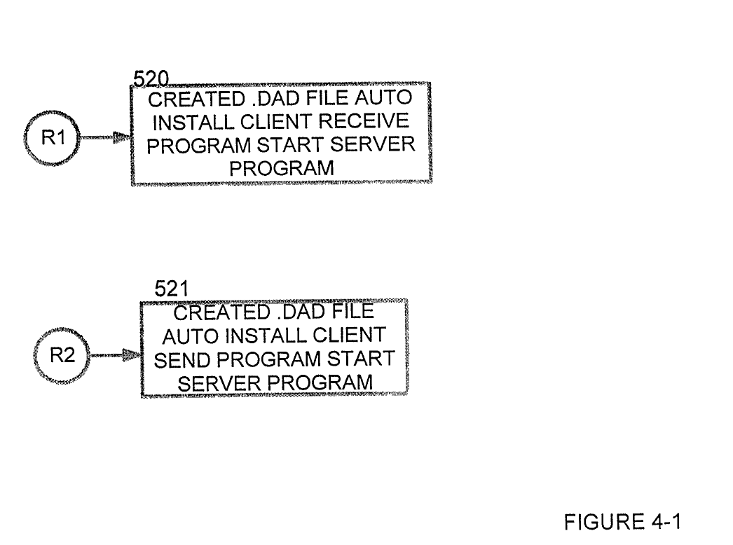

The sender may also be presented with the options to specify notifying and protection methods to ensure the security of data being sent through the system to the valid recipient. For registered (in-network) recipients, sender may enter the account name of the recipient. The notification method may be instant notification via DAD client-server communication, e-mail, or other methods. Recipients may be requested to enter their passwords to validate the identity. For non-registered (out-network) recipients, the notification method may be e-mail or other methods. The recipients may also logon to the system via a web page and enter a PID) to query and download the package (FIGS. 3, 4,4-1). The recipients may be requested to enter a package password set by the sender.

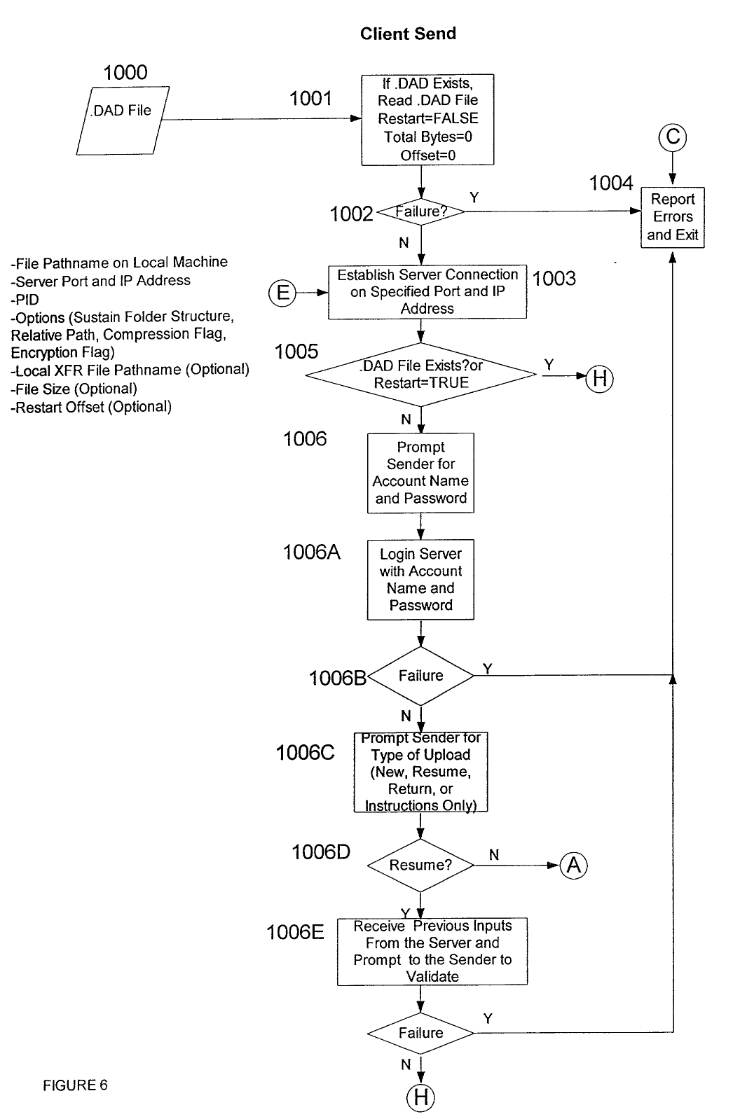

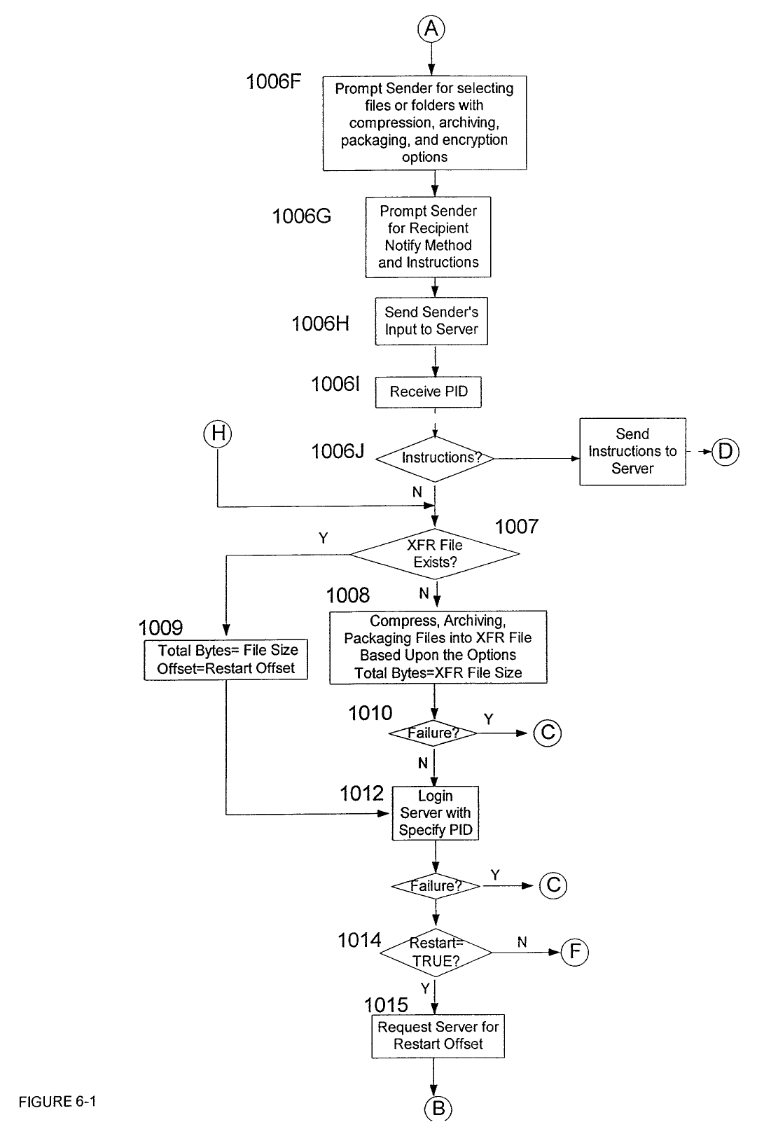

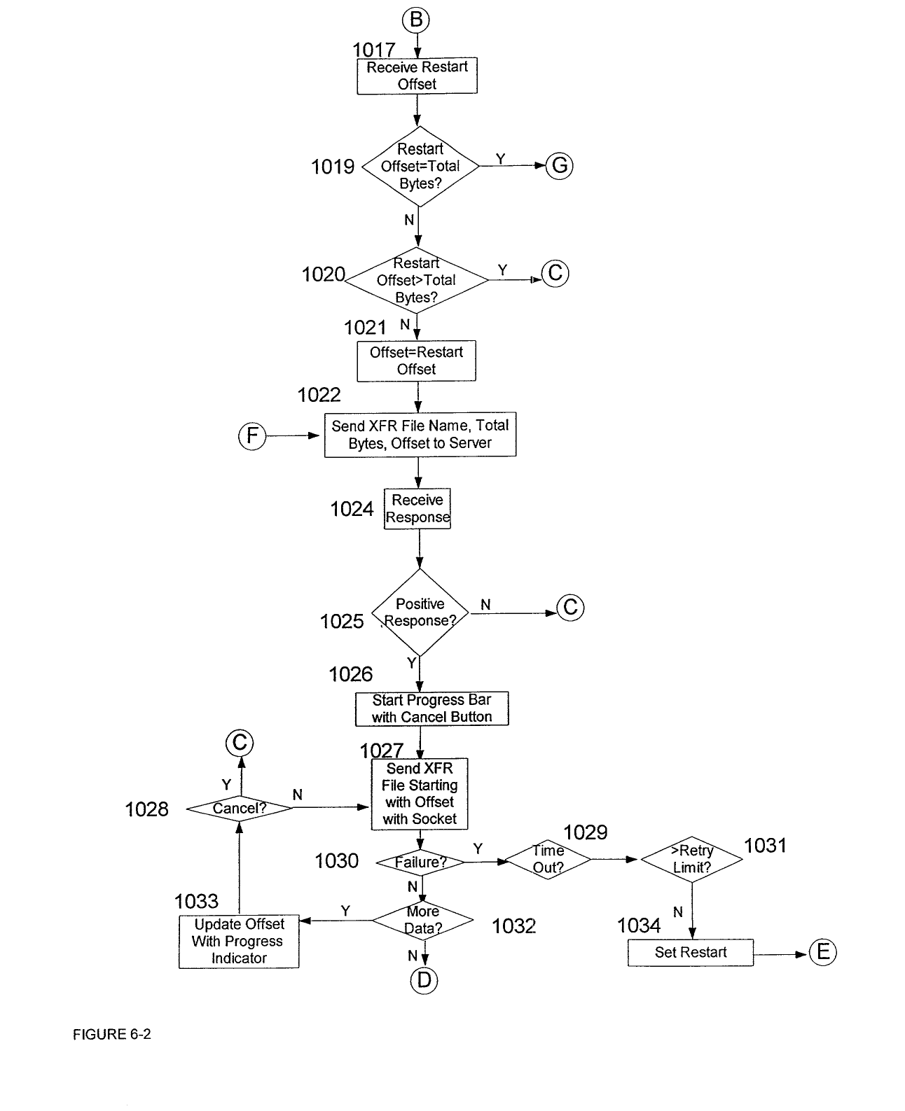

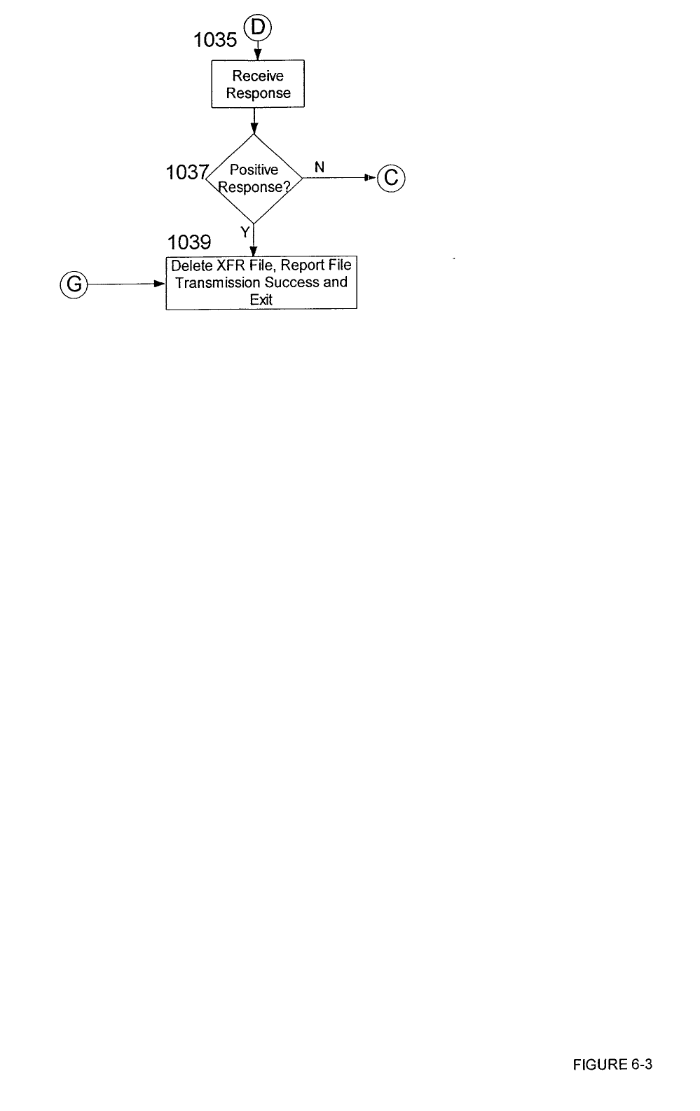

Step 1 illustrates the initiation of the process. The sending device communicates with a DAD server via web page or pre-installed client software to access account, address book and tracking information (FIGS. 3 through 3-D-5). The DAD server retrieves information from a database, and processes and displays information to the sender. The client software may be automatically downloaded to the sender computer to facilitate file transfer, and may include file compression, archiving, and packaging capabilities, as described in FIGS. 6 through 6-4. An encryption method (e.g., SSL), may be used to encrypt communication between client and server.

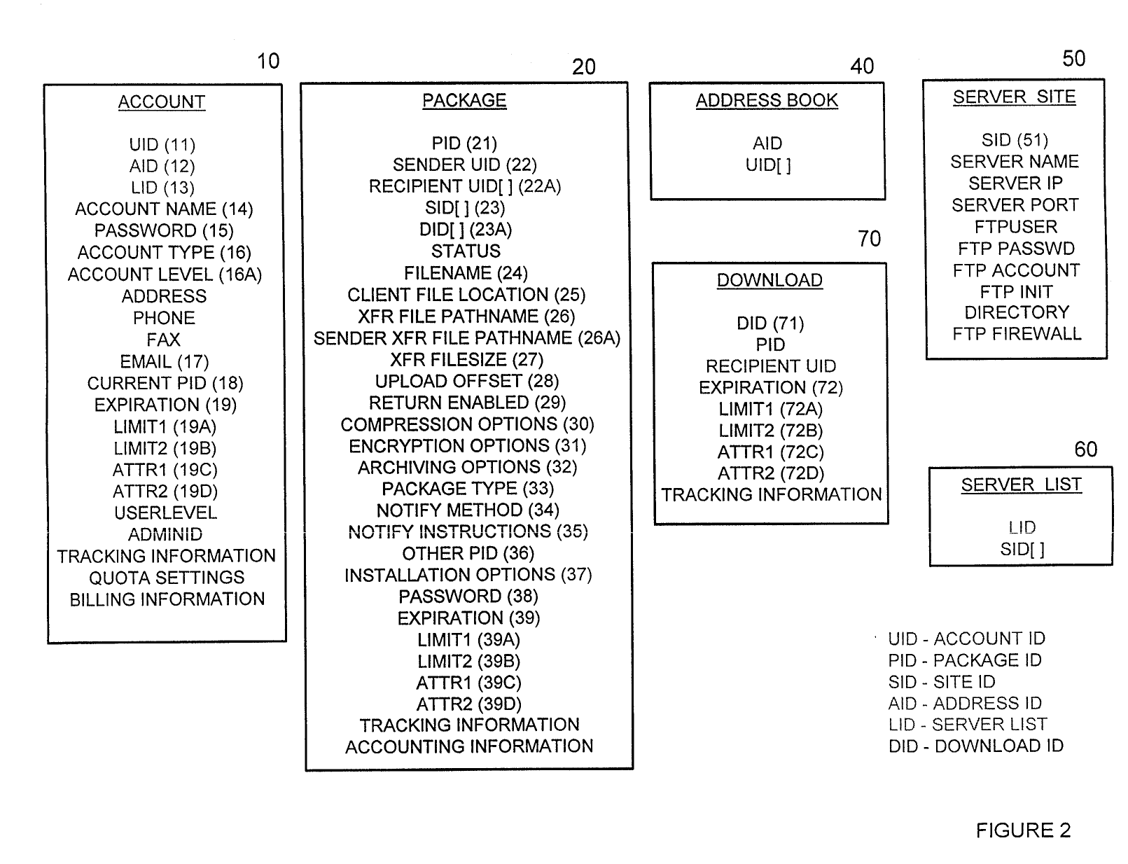

In Step 2, the client software communicates with the DAD server software to transfer the package and log the transfer data. The client software may also communicate with the DAD server to send an instruction only package, that will in turn request the server to transfer a pre-existing server package (i.e., a package already existing at the server at the time the instruction only message is sent) to the recipients. Step 2a shows that the sending device may also initiate transfer of data from DAD server to Remote File Storage system without requiring that the file be located on the sending device. The Remote file information, such as location and access information will be logged and stored on DAD Server. The communication to upload a file from a client to the server, and from server to server, via TCP/IP and an application protocol are described in detail in FIGS. 6 through 6-4, 8, 9 through 9-2, and 11 toll-2.

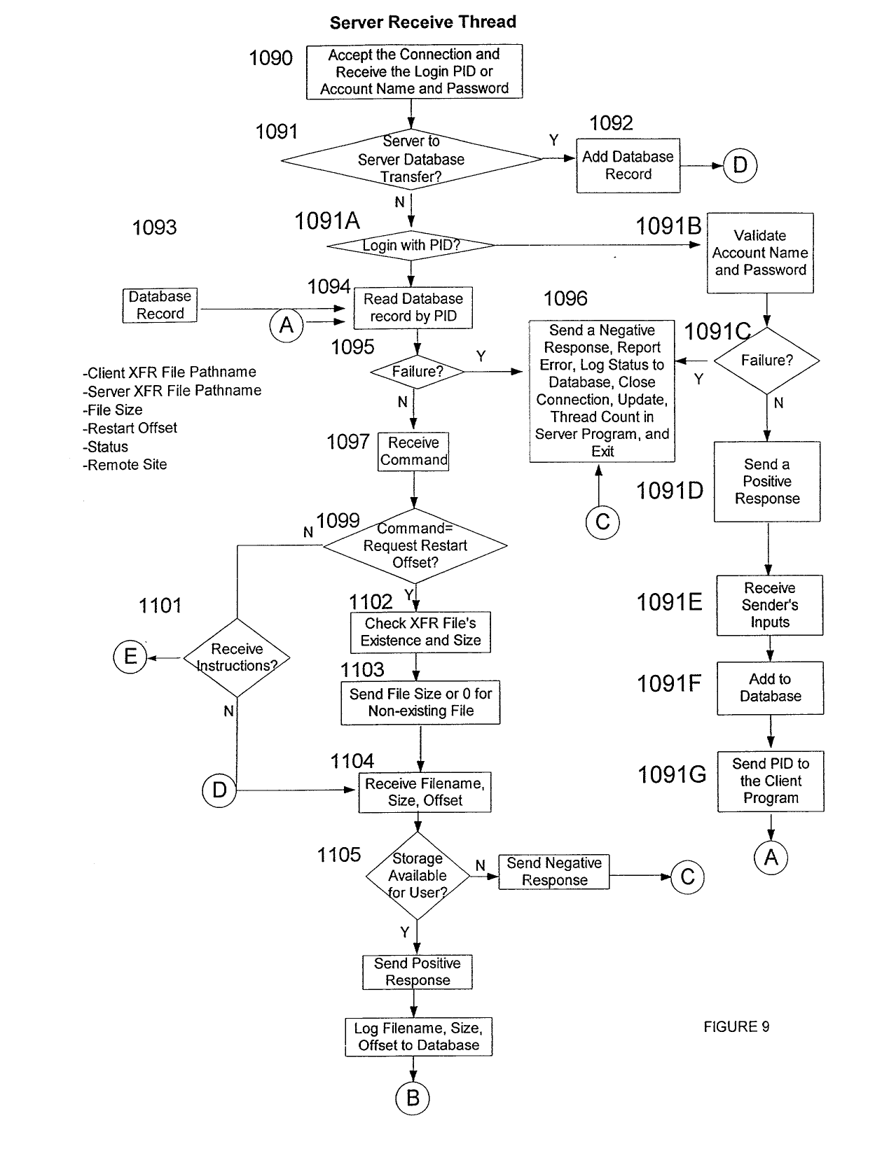

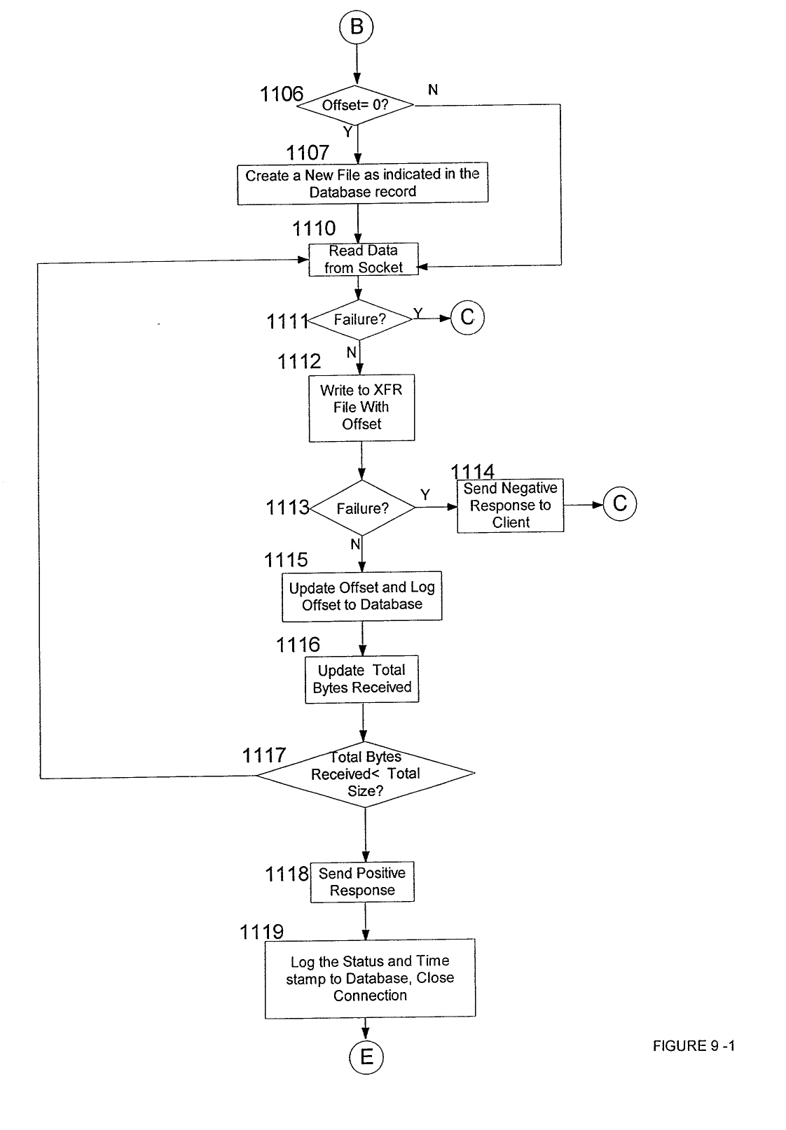

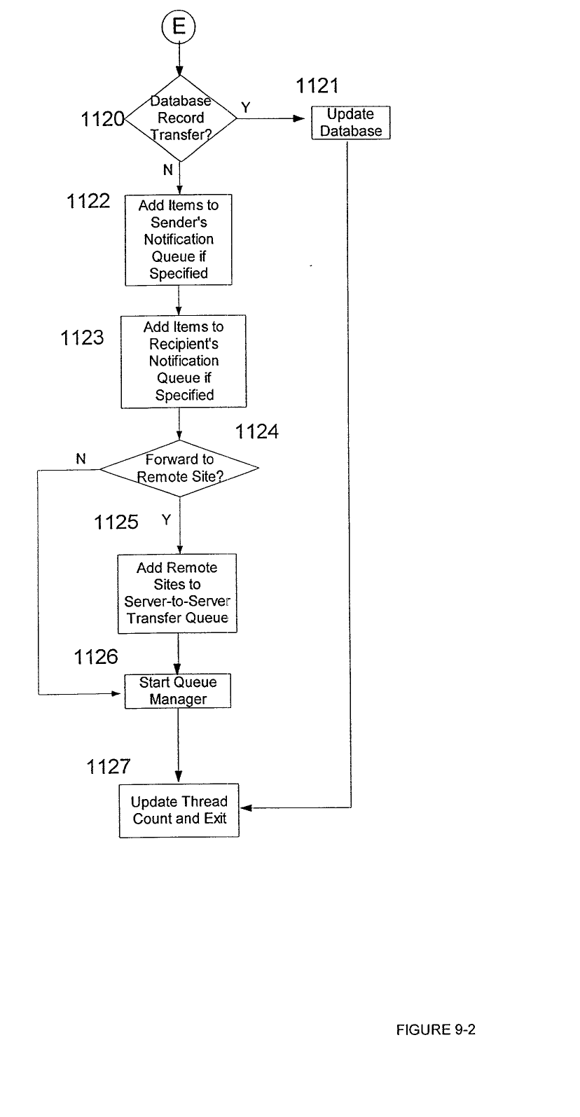

Step 3 initiates upon successful completion of file transfer to the DAD server. The DAD server may send a notification to the recipients (e.g., via e-mail), as described in FIG. 9. DAD server may also send a notification to the sender for the Package ID (PD) in 3a, as described in FIGS. 9 through 9-2.

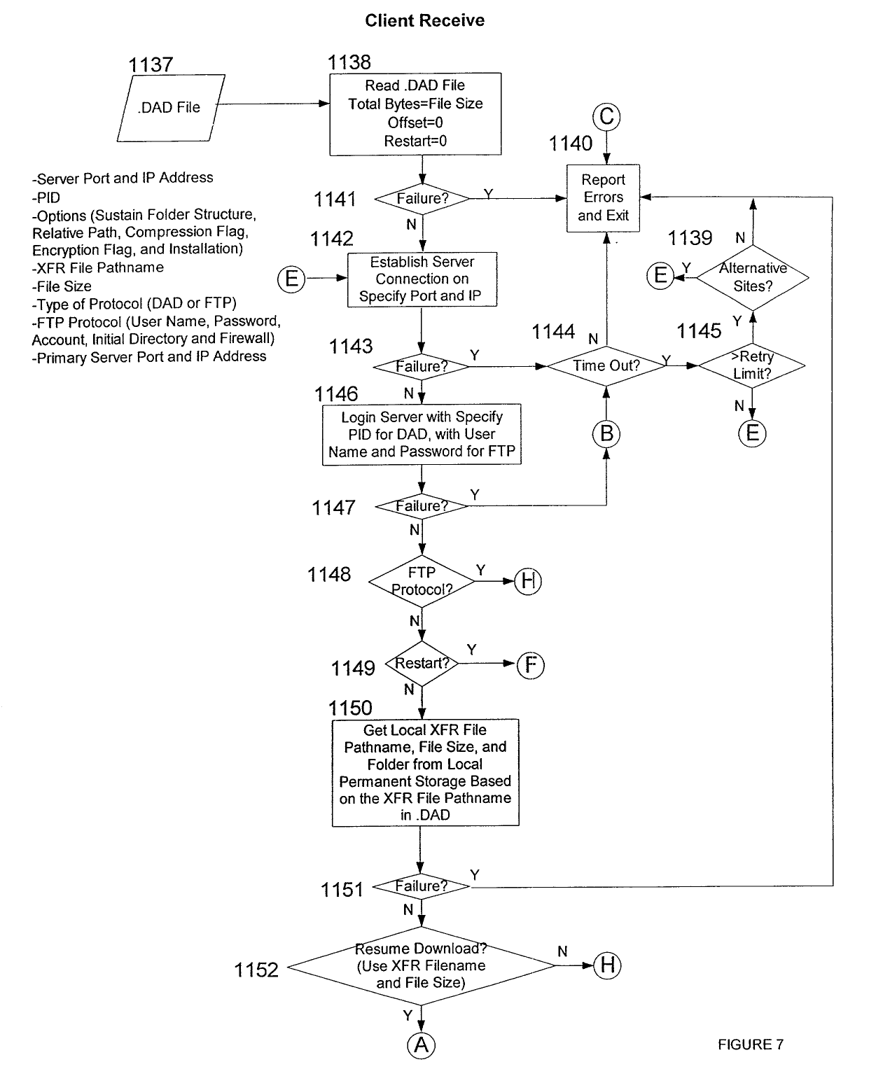

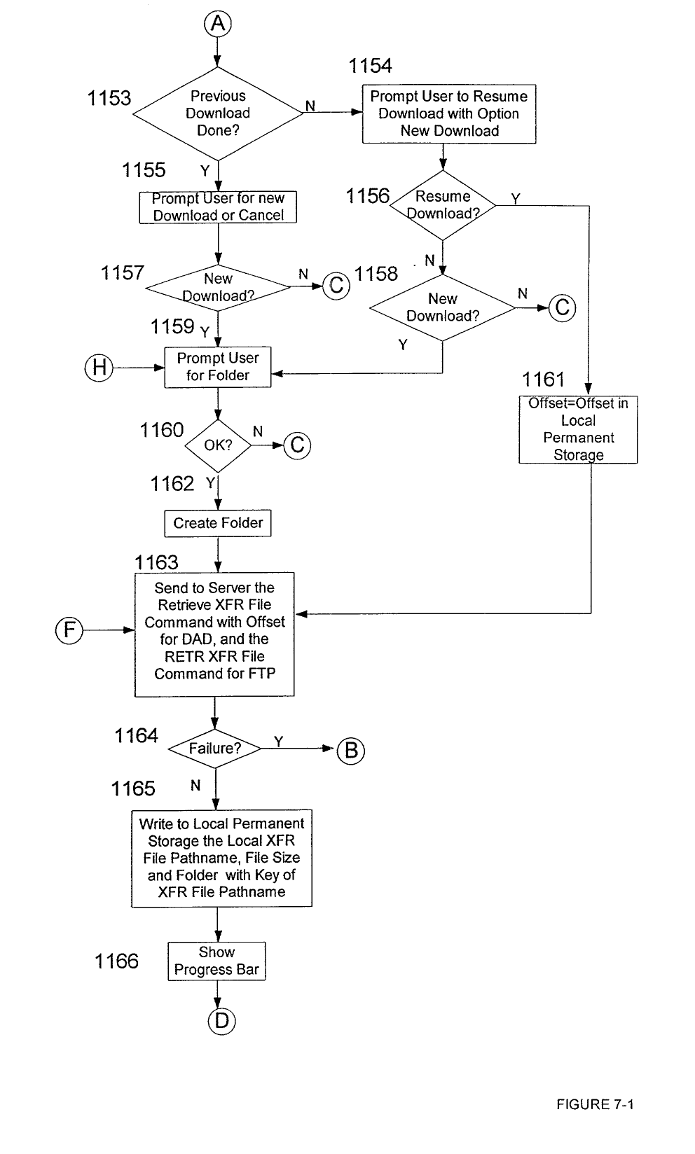

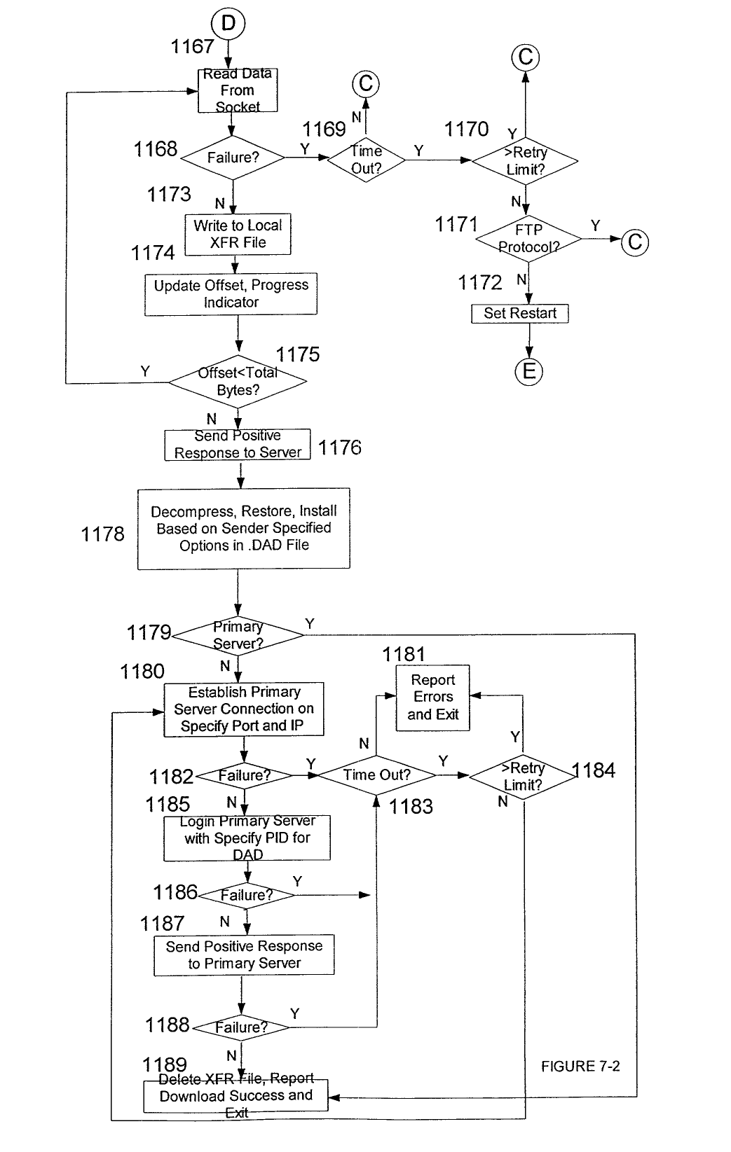

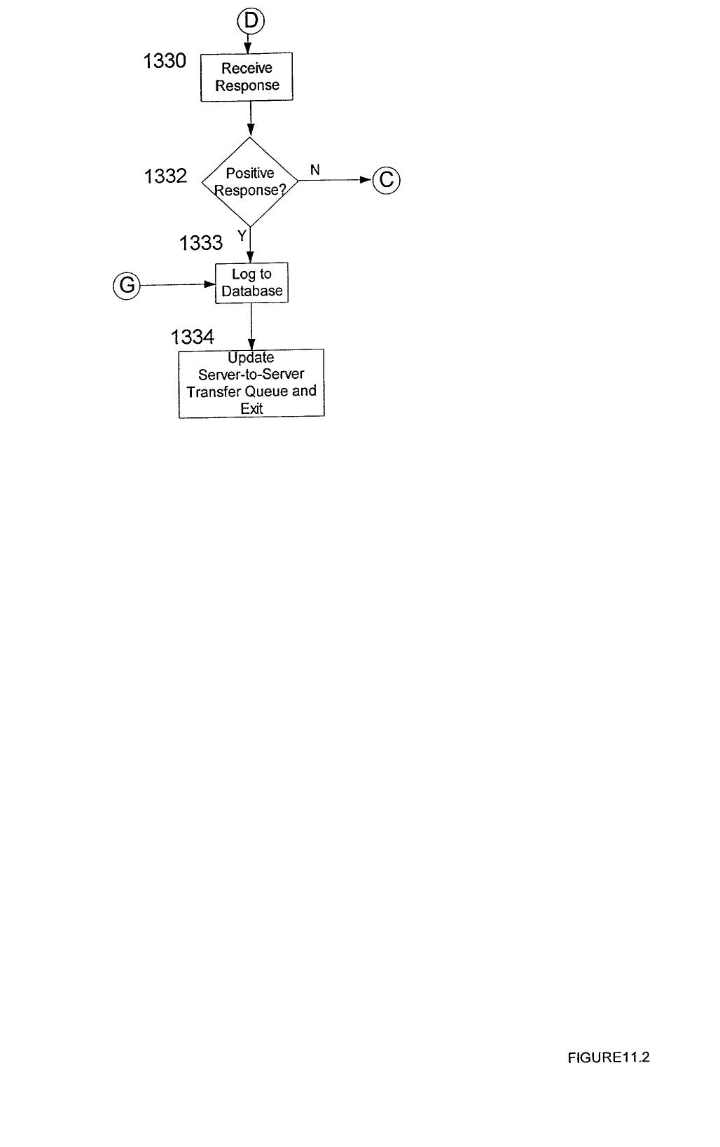

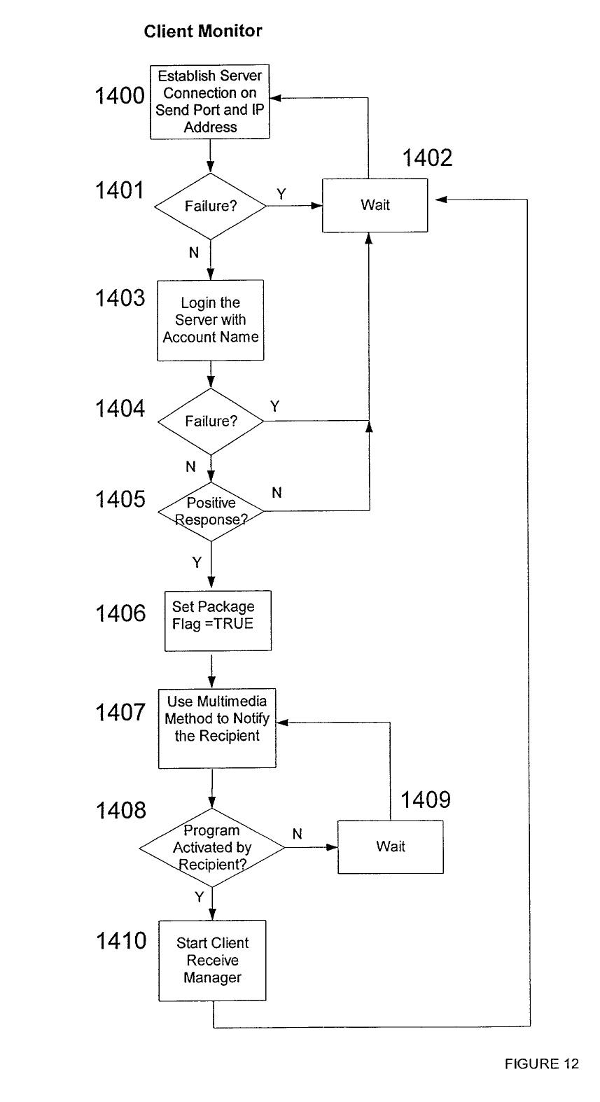

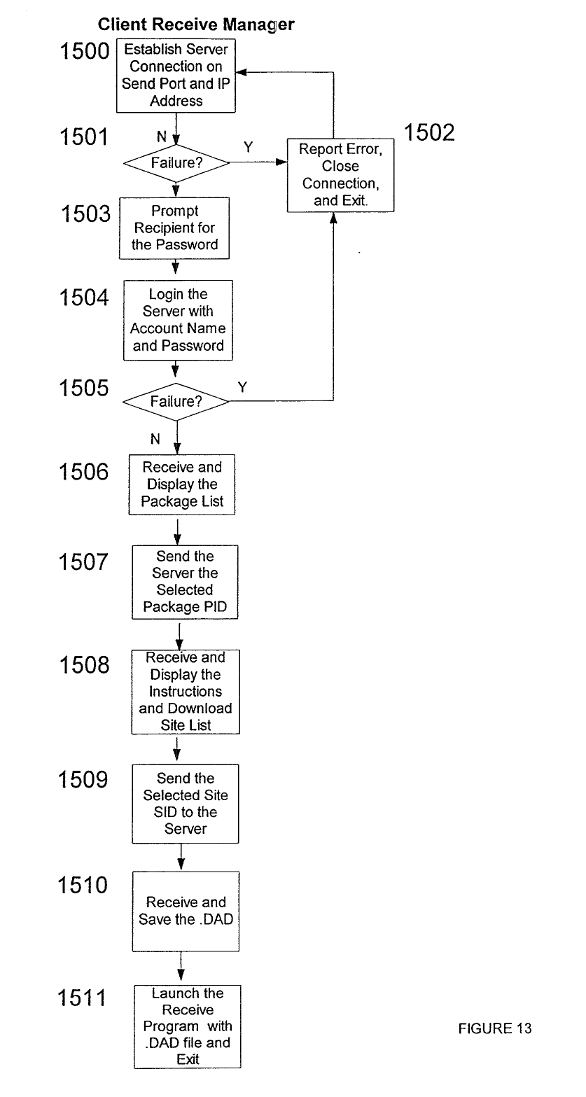

In Step 4, recipient may click on a link to a web page within the body of the e-mail, causing the DAD server to retrieve the information from the database, process the information, and display it to the receiving device. The DAD server may activate downloading of client software via the web page to the receiving device. Registered (in-network) recipients may pre-install the DAD client software. The client software may routinely connect to the server to determine if that user has received packages (see FIG. 12). When a package is received, the recipient may be notified by an audio-visual indicator, and may be prompted to download the package at that time. The recipient will receive the file, which may be available from multiple servers transparent to the recipient, as described in FIGS. 7 to 7-2. The client software may also interact with the recipient and communicate with the server program directly without going through a web page to download the package, as described in FIG. 13. An encryption method (e.g., SSL), may be used to encrypt communication between client and server.

In Step 5, the client software communicates with the server program via TCP/IP and an application protocol to download and decrypt the package or file to the recipient's computer. The client software may decompress, restore, and install the package for the recipient, as described in FIGS. 7 through 7-2, 8, and 10 through 10-1.

The recipient may have the option to return a modified file to the original sender by using either special links included in the original e-mail message (FIGS. 3, 4 and 4-1), signing onto the server via a web page and entering the original package identification, or running a pre-install client send program described in FIGS. 6 to 6-4, and initiating a return file transfer on that display, as shown in Step 6.

In Step 7, the sender may receive a notification (e.g., an e-mail message), of the return file transfer and downloads the revised file using client software. If the sender pre-installs the DAD client receive software, the client receive software may routinely connect to the server to determine if that user has received packages (see FIG. 12). When a package is received, the recipient may be notified by an audio-visual indicator (or other indication method/device), and may be prompted to download the package at that time. The recipient will receive the file, which may be available from multiple servers (transparent to the recipient) as described in FIGS. 7 to 7-2. The client software may also interact with the recipient and communication with the server program directly without going through a web page to download the package, as described in FIG. 13.

FIG. 2 is an exemplary DAD server database design block diagram listing examples of data records stored in database, including Account (10), Package (20), Address Book (40), Server Site (50), Server List (60), and Download (70). File transfers are recorded by sender UID (User Identification) (11), recipient(s) UID(s), PID (Package Identification) (21), SID(s) (Server Site ID) (51), DID(s) (Download ID) (71) along with other pertinent information. Each PID (21) is preferably universally unique and includes a server site URL (e.g., the URL of the DAD server where the file is first received), account ID, and unique package number for the account. The server site URL provides the universal uniqueness to the PID to particularly assist the server-to-server transfer. When the sender makes a request for file transfer, package, recipient accounts and download records may be added into the database.

The account record may contain the pointers to the address book (12) and server list (13) for sender to select, and to the Current Package (18) for resume upload. The account name (14) and password (15) are created when the sender or recipient registers with the system. Each account may include recipient, registered recipient, or sender (sender is qualified as registered recipient automatically) indicated in Account Type (16). Each type may include different authority levels in 16A (i.e., sender has authority with return package), with the sender having the authority to issue multiple downloads and the recipient having preinstalled client software and can be notified via instant notification. Unregistered recipient account record may include only EMAIL (17) in the record. Each account may expire depending upon the expiration method defined in 19 (i.e., period of time, number of download, Limits (19A and 19B), and Attributes (19c and 19D)).

The package record (20) may contain the pointers to the sender (22), recipients (22A), and server (23 for server-to-server transfer), Sender File Names (24) and Location (25), and Server XFR File Pathname (26). The XFR file (26) is the archive file stored on the server with a universal unique pathname based on the PD such as \URL\UserID\package number. The sender XFR File Pathname (26A), XFR File Size (27) and Offset (28) are stored for assisting the resume and automatically upload. The packaging method (30-32), notify method (34) and instructions (35), along with tracking and accounting information are also stored in the package record (20). Each package may be expired depending upon the expiration method defined in 39, i.e. period of time, number of download, Limits (39A and 39B), and Attributes (39c and 39D). Each package may have password (39) protection set by the sender. For a return package, a new package record will be added into the database with a PID (36) of the original package record. The PID of the return package record will be saved to the PID (36) in the original package record.

FIG. 3 illustrates a general outline of the interface as may be 15 displayed by the client browser, comprising User Login, Client Browser screen components: Transfer (XFER), Tracking (TRACE), Address Book, and Account. The User Login process requires user or client identification and password.

FIG. 3-A Transfer: Sender enters relevant information about the files 20 to be transferred. File information includes names of the files, locations of the files, and other descriptive information as shown in A of the diagram. In the preferred embodiment, the sender may click the onscreen option labeled “Transfer”. Upon receiving the transfer request, the DAD server starts the program, processes the file transfer request, and generates and sends client software embedded in HTML to the sender (as shown in B of the diagram) stores information for FTP transfer in the database, or initiates DAD server-to-server transfer.

FIG. 3-B Tracking: Sender has the option to track files previously sent. To perform this option, the sender preferably clicks on the onscreen option labeled “Trace”. This action retrieves information stored in the database and displays it in a convenient form for the sender. This information includes records of the recent files that have been sent. Recent may be defined as such cases as those recent in time, most recent files sent to a particular recipient, or most recent files sent containing a specific file or file attributes. As shown in FIG. 3-B, there are four alternatives to locating the information. This information (or history) is stored in the database; each entry will be stored with its own unique identification.

One available option as illustrated by FIG. 3-B in 300 is to re-sort the data that is currently displayed to the user. This is implemented in order to maximize customization and provide the sender with easier access to relevant information. By clicking on a column heading, the sender is able to rearrange data by column. For example, in FIG. 3-B-1 selecting the “To” heading in 302 initiates 301. Here, the system is accessing the database and rearranging the information as per the sender's request. The information is then redisplayed in 302. The same process is applied to format the information under the specifications of the other headings. The display seen by the sender is similar to that of the display seen before the process; that is, it uses a similar layout, but the information displayed has been altered as per the sender's instructions. In 303, the sender can now locate the proper identification of the file that is to be tracked.

If desired information is available or found, the sender can select the identification as in FIG. 3-B-2. When the corresponding link to the desired information is clicked, the system retrieves the unique details from the database associated with that identification in 306. The package details are then displayed (307) in a form convenient to the sender. The sender is able to view the history of the specified package, including transfer timestamps and file properties. If the desired information is not found, the sender has the option of returning to 301 to re-sort data in another manner.

The sender also has the option of displaying the entire file list. When the sender selects “List All” in FIG. 3-B in 300, the system processes the request in FIG. 3-B-3 in 308. The request is sent to the server, retrieved from the database, and the information is displayed to the sender as shown in 20 FIG. 3-B-3 in 309. When the sender is able to locate the desired file, the action of selecting the appropriate file will initiate 311, which initiates the same process mentioned in FIG. 3-B-2 in 306 and 307.

If the sender is unable to locate the desired file, the sender may re-sort data by selecting a heading as mentioned above. The process of FIG. 3-B-3 in 312 corresponds to that of FIG. 3-B-1 in 301. The display will then be reformatted as in FIG. 3-B-3 in 313. As before, if the sender locates the desired file, the sender may then click on the appropriate file to display the unique details that are associated with it.

A fourth option to locating the file transfer details display associated with a file is to “search” or query the database as illustrated in FIG. 3-B-4. In FIG. 3-B-4 in 317 the sender enters keywords or queries into the appropriate fields to define the search criteria. This information is submitted to the server, initiating the process shown in FIG. 3-B-4 in 316. The system uses the user-defined criteria to search the database and reformat the display to show the requested information to the sender.

The sender may elect any of these options at any time while in the recent file display. There is no order in which the sender will have to choose the manner in which the file is searched. That is to say, the sender may choose to search, re-sort, re-sort again, display the fill file list and so on until the desired information is located.

FIG. 3-C Address Book: The address book is based on a database that stores information such as names, e-mail addresses, phone and fax numbers, instant messaging IDs. The Address Book also includes Group names to allow DAD file transfer to an entire group of recipients. DAD system allows the creation of new groups based on selection of individual recipients or certain criteria. The system is implemented to provide a database that can be accessed, searched, queried, and modified by authorized users in order to reduce time and effort associated with file transfers. The address book includes entries input by the sender that are unique to each sender.

Preferably, the sender clicks on the menu option that is labeled ADDRESSES to access the address book database entries that are associated with their unique user identification number. This action retrieves information from the database and displays that information in a convenient form for the sender. This display lists all entries currently available to that user in the database. As the layout in FIG. 3-C demonstrates, the sender will be presented with several options associated with each address book entry. These options will simplify tasks such as maintenance and selection of recipients. Sender will be able to select one or more entries to which they can transfer files.

Additionally, the sender may be able to add new entries, modify existing entries, delete existing entries, or send an e-mail message to a recipient indicated in an existing entry. The sender may at any time have the option to return to the main menu display by clicking on the appropriate link on the display. Descriptions of each function will be elaborated below.

The sender may be able to select one or more entries to which a file will be transferred. To do this, the sender checks the box in address book 400 next to the appropriate name or names as seen in FIG. 3C. When requested by the sender, the selected recipient addresses will be input into the “To:” field on the message display as depicted in FIG. 3-C in 404 and in FIG. 3 in 102.

The sender has appropriate control over the address book entries associated with their unique identifier located in the database. As this database may contain no entries relevant to a specific sender, or it may not contain an entry appropriate to the digital package to be sent, the sender may want to add an entry. By selecting “Add an Entry” FIG. 3-C in 401, the sender will be able to add new entries to the address book. The available fields for input may include fields such as First Name, Middle Name, Last Name, Nickname, Mailing Address, and E-mail Address, among others. In order to successfully add an entry, certain “key” required information must be entered. If any of these required fields are left blank, the sender will receive an error message indicating that these fields may not be left blank.

Once all of the desired and required information has been entered and submitted by the user, the system will display a confirmation message in 407 showing all of the information entered in the previous action as depicted in FIG. 3-C-1. If the user is satisfied with the entries, they will again submit the information and the information will be added to the appropriate records in the database as shown in FIG. 3-C-1 in 408 and a completion page will be displayed with the entered information 409. At this point, the sender may have the option to modify this information or return to a previous menu.

As the entries in the database that are relevant to the sender's unique ID may not be correct or up-to-date, the sender may have the option to modify the information. To modify an existing entry, the sender clicks on the appropriate option located on the display. The sender will be able to change, add, or delete information in any of the available fields as is necessary. This process can be seen in FIG. 3-C-2. To the sender, this process is virtually identical to that of adding an entry. It differs only in that the sender sees a page confirming modification 411 rather than confirming a new entry. Once the desired information has been modified, the sender may submit the information to be processed by the server. The information is then updated in the appropriate database 412.

From time to time it may be necessary to remove an entry from the database. To delete an entry, the sender clicks on the appropriate option on the main address book display. This process is seen in FIG. 3-C-3. Once the request is received, the sender will then be directed to a confirmation page 414 to verify that the entry selected is to be deleted. The sender will have the option to confirm, or cancel this function. If the sender cancels, then nothing is changed. If the sender confirms, then the information is deleted from the database 415 and cannot be restored except by being re-entered manually by the sender.

Each entry has a unique details page associated with it. When the sender clicks on a name in the Address Book, the information is retrieved from the database and the details for the entry are displayed to the sender. If the sender clicks on the e-mail address entered in the mentioned field, the sender will be able to send an e-mail message to the recipient. The e-mail will be sent using the sending computer's default e-mail client. The sender may also have the option to Select, Modify or Delete the entry as described above.

FIG. 3-D Account Information: The account information for each unique user ID is stored in a database that contains information such as contact name, company name, address, telephone number, e-mail addresses, and any other information relevant to the system administrator. The system is implemented to provide a database that can be accessed and modified by authorized users in order to authenticate users based on ID and to monitor the activities of possible sub-users.

There may be multiple user levels that include designations such as administrator and sub-users. The administrative level would have access to various types of sub-user information, such as account records, recent transfers activated by that user, and other maintenance options. Access to this information is provided only to those administrators with access privilege to a specific set of users, as dictated by a database. Administrators would have the option to set up and configure sub-user accounts associated with that administrator and to which that administrator would have certain access privilege.

Depending on the user level as indicated in the database, a different display may be presented to the user. If the user is of a sub-user level, they may be displayed a page on which they could view and modify their own unique account information as described below. If the user is of an administrative level, they may be displayed their own unique user information as well as a listing of sub-users for that Administrative account. They may have the ability to view and modify their own information as well as the information of sub-users. In addition, they may be able to add or remove sub-users at their discretion, as described in more detail below.

FIG. 4 illustrates the recipient being notified by the DAD server and the ensuing communication with the server.

When a file is transferred, a package ID is generated for that package. This ID can be used to track the package, or optionally re-download that transfer at a later time. An e-mail notification, as shown in FIG. 4 in 515, may optionally be sent to the recipient(s) indicating that a file transfer has been initiated. Contained within the message will be a unique link in 516 to the DAD server. When the recipient clicks on the link, the system sends the request to the database with a unique ID. FIG. 4 in 518 illustrates Recipients options the first time they access the system. FIG. 4-1 in 520 portrays the process that the system undergoes as a result of the initial access.

Like the sender, the recipient will have the option to track the history of the specific file that has been transferred. The file will have a unique ID associated with a unique details page. These details will then be displayed to the recipient. Embedded client software is automatically downloaded from the DAD server to the recipient's computer via a web page to facilitate the file download to the recipient's computer. The recipient will select the appropriate option, and this will initiate the retrieval process from the database. In its preferred environment, this may be useful to recipient in cases where originating information is desired, or when the package has been revised and returned.

If the recipient has already been to the file information page specified above (block 518), the system will detect this as shown in FIG. 4 in 519, such as in the case of re-download or resume download. FIG. 4-1 in 521 portrays the process that the system undergoes as a result of additional visits. In addition to the options mentioned above, the recipient will be able to return the file, modified or unchanged, to the sender in subsequent returns to the file information page.

FIG. 5 shows a set of programs for the DAD file transfer operation through client-server communication. They complete file transfers from client to client through the DAD server. The process is further explained in FIGS. 6 through 13. These figures illustrate the processes of Client Receive (902), Client Send (901), Server (905), Server Receive Thread (907) and Server Send Thread (906), the Server To Server Upload (908), Monitor (903), and Client Receive Manager (904) programs. The client programs may be automatically downloaded to the client computer through a .cab file in Internet Explorer, a .jar file in Netscape 4, or via a Web download with other web browsers.

The DAD system uses hypertext processors to generate a .DAD (900) file that is embedded in a web page. This file provides the client program with both users and DAD server requests. Web browser then activates the client program (901 or 902) for the embedded .DAD file in web page. When the client computer executes the client program, it communicates with the DAD server to send and receive files via TCP/IP and DAD protocols (explained in detail in FIG. 6 through 13).

If the client programs (902, 903, 904) are preinstalled for instant notification, the monitor (903) program may notify the user and start the receive manager (904) program to interact with the sender directly and communicate with the server program, and to start the receive program (902) for the transfer without going through a web page. The server port and IP address may download with the client program from the server and be saved locally or may be saved inside the client program.

If there are notifications to send out, the program will communicate with the queue manager (909) to add the item to the defined queue, i.e. sender notification queue, recipient notification queue, or server-to-server transfer queue. The queue manager will read from each queue and send the item to the program associated with the queue, i.e. server upload program (908) for the serve-to-server transfer queue or notification generator (909) for the sender or recipient notification queue.

FIG. 6 illustrates an example process, which can be performed by executing the Client Send program.

The exemplary process performed by executing the Client Send program to send a file or instructions to the server with or without web page is shown in FIG. 6. In particular, it describes how to use application protocol to initialize, encrypt, auto restart, resume, returned file upload, file upload, and instruction delivery in detail in FIG. 6. The requests from the sender via web page are saved in the database on the server. Through the .DAD file the client program obtains the requests from the sender. Parameters in the .DAD file for this program include the pathnames for the files on the local machine, server port, IP address, ID, XFR file pathname, file size, restart offset, the archive options of the sustain folder structure, relative path, compression and encryption flags, as seen in 1000. The program reads the .DAD file if it exists as indicated in 1001. If failure occurs as determined in 1002 the program reports the error and exits.

The program establishes and encrypts a connection with the server 20 using the port and IP address in 1003.

If the .DAD file does not exist, the program interacts with the user directly in 1001-1006.

The sender has the option to cancel a lengthy upload and resume the upload at a later time. When the resume transfer is requested via web page, the XFR file name, file size, and restart offset are available in the .DAD file. The Send program will use those parameters to determine whether the resume request is valid or not. If it is valid in 1007, the program will resume uploading portion of the file and so indicate in the restart offset. If it is a new upload, the program reads, compresses, archives, and packages the specified file(s) into a XFR file based on the options in 1008. If a failure occurs during compression, archiving, packaging, or the writing of the XFR file to the local storage device, as indicated in 1010, an error is reported and the program exits as indicated in 1004.

The program sends a login PID via an application protocol in 1012. The server will use this PID to verify the user and to obtain the database record regarding this transfer and synchronize with the client Send program. If the Send program loses its connection with the server when uploading the file, it will try to reconnect to the server with the same PID for the restart without sender intervention.

If it successfully logs in to the server, the Send program then needs to determine how much of the file has been reliably received on the server. In 1015, the Send program sends an application protocol to the server for restart offset. The server receive program illustrated in

FIG. 9 will check the file size and return the size as restart offset for the client Send program to relocate the file pointer to the restart offset. If the total number of bytes reliably received by the server indicates the previous transfer is completed in FIG. 6-2 in 1019, it proceeds to FIG. 6-3 in 1039 to complete the process. Otherwise the Send program will relocate the pointer to the restart offset in FIG. 6-1 in 1021. In FIG. 6-2 in 1022 the Send program sends an application protocol with the current XFR file name, file size, and the offset to the server to support resume operation.

The sender can cancel the ongoing file upload. A progress bar with a cancel button is displayed for the sender to facilitate this need in FIG. 6-2 in 1026. The program sends the data to the socket in FIG. 6-2 in 1027. If the send to the socket command fails and indicates a time out error, the send program will automatically try to connect with server in FIG. 6-1 in 1008. The automatic restarts from step in FIG. 6-2 in 1034 also may be limited in FIG. 6-2 in 1031, in number or in time, allowing automatic restart. If sender cancels the operation (via cancel button), the program goes to FIG. 6 in 1004 to report and exits. If the XFR file has been sent successfully, the program waits for a positive response from the server, deletes the copy of the XFR file from the sender computer, reports a successful file upload to the sender, and exits.

FIG. 7 illustrates an example process which can be performed by executing the client receive program.

FIG. 7 describes an example process of downloading a file to the client from the download site and delivery of the download notification to the primary DAD server with or without web page. In particular, it describes how to use application protocol to initialize, encrypt, auto restart, resume, and auto reconnect to a different server to resume file download in detail in FIG. 7. When the client computer executes the client receive program, the executed client receive program communicates with the DAD server using TCP/IP and an application protocol or FTP server using FTP protocol to download the file. If a connection to the download site fails, a connection attempt may be performed again. An alternative connection to a different server also may be attempted.

First, the program read the .DAD file in FIG. 7 in 1138. The .DAD file includes parameters of XFR file pathname and file size, server port and IP address, type of protocol, package options (such as sustaining folder structure, relative path, compression flag, encryption flag), and optional FTP related parameters such as user name, password, account, initial directory and firewall data) in FIG. 7 in 1137. If the download site is not the primary server site, the IF and port of the primary site are provided in the .DAD file too. If an error occurs, the error will be report to the user and the program exits. An attempt to establish a server connection from a specified port and encrypt the communication for the session is illustrated in FIG. 7 in 1142. If there is a failure in enabling the server connection on a specified port and the error is the result of a time out in FIG. 7 in 1144, a retry will be attempted if it is within the retry limits. If the retry limit had been exceeded FIG. 7 in 1145, an alternative connection may be tried as indicated in FIG. 7 in 1139. Depending on the type of download site, the corresponding login method is used in FIG. 7 in 1146.

The recipient has the option to cancel a lengthy download and resume the download at a later time for the DAD download site. When the receive program is executed, it has to determine whether the operation can be resumed in processes FIGS. 7 and 7-1 in 1150-1158. It uses a permanent storage method (e.g., cookies), to save previous local XFR file name, file size, and folder using server XFR file name as a key on the client computer. If the XFR file name and file size in the local permanent storage are the same as ones indicated in the DAD file (in 1152) and the file size of the existing local XFR file is smaller than the file size specified in the local permanent storage (in 1153), then this operation can be resumed if the recipient agrees. The status of the previous transfer will be presented to the recipient to determine whether resume or initiate a new download is desired (1154 and 1155). If a new download is preferred (1157 and 1158), a destination folder for the files has to be determined in FIG. 7-1 in 1159.

The client then uses an application protocol to send a read request to the download server, and a specified offset for DAD server, or uses a FTP protocol to send a RETR command to FTP server in step 1163 in FIG. 7-1. In step 1165 in FIG. 7-1, the program will write to the local permanent storage (e.g., cookie), the local XFR file name, file size, and folder using server XFR file name as a key. Data received at the client is read from a socket. If the socket indicates that the valid data is not available, as determined in step 1168 in FIG. 7-2, the socket will continually read if the error as determined in step 1169 in FIG. 7-2 as a time out operation.

If the retry limit is reached, the program will try to automatically restart of the downloading file by reconnect to the server or the alternative server in FIG. 7 in 1142. If valid data is read in step 1167 in FIG. 7-2, then it writes the data to the XFR file. If an end of file condition is reached in FIG. 7-2 in 1175, the program sends a positive response to the server and updates the attributes of the transfer.

In step 1178 in FIG. 7-2, the program will use the options specified in the DAD file to decompress, restore, and install files based upon the sender-defined options (1137) in the .DAD file. If the download site is not the primary site for this transfer, the program will try to establish the connection to the primary server and send a transfer notification as indicated in steps 1180 to 1187 in FIG. 7-2. The program deletes the XFR file, reports the download successfully, and exits as seen in FIG. 7-2 in 1189.

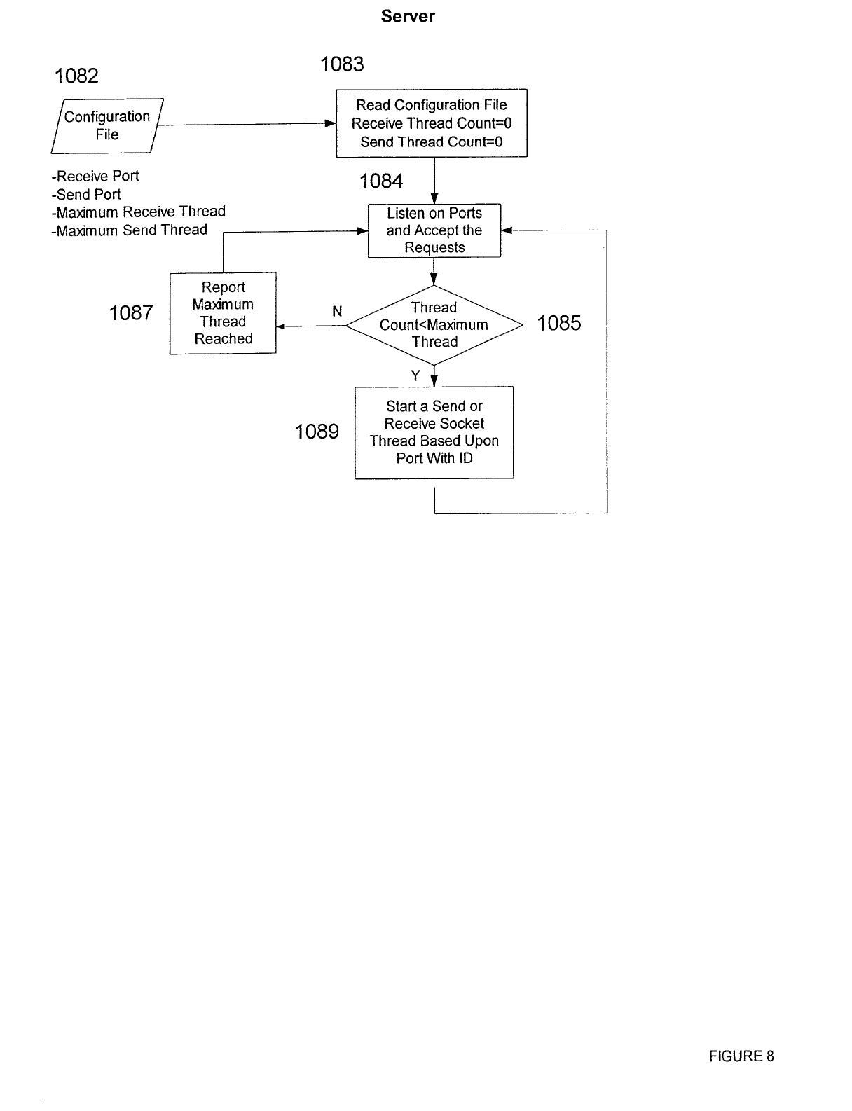

FIG. 8 illustrates a preferred example of the DAD system server program. The server program has a concurrent design. It creates a socket and binds to the defined address for the DAD service being offered. It leaves the socket unconnected. It places the socket in the passive mode, making it ready for use by a server. It listens to the port and accepts the requests from the client, and creates a slave thread process to accept the connection and handle response. The thread program receives a connection request, reads requests and sends back responses. Since each server has different capacity and available ports. A communication configure file is designed to provide server ports and maximum threads for server program to handle configurable and concurrent transmissions.

FIG. 8 in 1082 illustrates a configuration file that can be changed by the server administrator for the sending and receiving ports. Furthermore, it shows thread counts that should be adjusted according to the system capacity for handling the maximum number of users login. It listens on the ports and accepts the request in FIG. 8 in 1084. If request is received and is within the limit of the system capacity in step 1089 in FIG. 8, a Receive or Send thread program is created. The thread program will then receive the connection upon creation and interact with the client using the connection, read the response and send back the response repeatedly. If the thread count is reached, a report is generated for the server console and the program will go to step 1084 in FIG. 8 for the next client request.

FIG. 9 describes an example DAD server receiving a file from sender or from another server, receive instructions, or receive database record from another server. In particular, it describes how the receiving thread processes a request for a partial file transfer. It also shows how, upon completion, the program starts the other process for continuing data transfer to other sites if requested, or sends notifications to the sender or recipients if specified. First the receive thread will accept the connection request (i.e., socket for the connection) and receive the login ID in FIG. 9 in 1090.

There are four different types of requests to receive data. Based on the PID and login method it can be client to server file transfer via web page, using PID, client to server file transfer without web page (using Account Name and Password in 1091A), server-to-server file transfer, or server-to-server database record transfer. If it is a database record transfer, it will create the database record first in FIG. 9 in 1092 and proceeds to step 1105 in FIG. 9 to receive filename, size and offset from the other server. For file transfer with web page, it will get the package record in FIG. 9 in 1093 from the database using the ID in 1094. If an error occurs in FIG. 9 in 1095, the ID is invalid or the database record can be retrieved. The program will report the error, log status to database, close connection, update thread count and exit as seen in FIG. 9 in 1096. For file transfer without web page, the program first validates the account name and password in 1091B. If it is valid, the program sends a positive response to the client in 1091D. Then it waits to receive the sender inputs in 1091E, adds it to the database in 1091F, and sends a PID to the client in 1091G.

If the command received in 1097 is an instruction to send a package which is pre-existing on the server (1101), the program will skip the receive file logic and go to add item to sender or recipient notification queue in 1122 and 1123, and exit.

To support partial file transfer, the program may receive a command requesting restart offset in FIG. 9 in 1099. If the command is received, it will find out the file size, if exists in FIG. 9 in 1102, and send a response for the suggesting starting offset of XFR file in FIG. 9 in 1103. In FIG. 9 in 1104 the program receives a message indicating the XFR file name, total size, and the starting offset of the transfer. If there is storage available for this user in FIG. 9 in 1105, it sends a positive response; otherwise, it sends a negative response.

If a new file transfer is indicated by a zero offset in FIG. 9-1 in 1106, it creates a new file in step 1107. If the offset is equal to zero, then data is written to the XFR file from the beginning. If the offset is not equal to zero, then the data is writing to the file starting from the updated pointer location. In step 1110 the program reads data from the socket, writes to the file, and updates the database. If the current total bytes received is updated and indicates an end of file in 1117, a positive response is sent to the client in step 1118. Otherwise, more data is read from the socket in step 1 110 in FIG. 9-1. For receiving database record transfer, the program updates the database record and exits. If file forwarding to the other server is requested, the program adds the item to the server-to-server transfer queue in step 1125 in FIG. 9-2 and starts the Queue Manager in 1126. If notifications are requested in the database, it will add an item to the notification queues (1122 and 1123) and start the Queue Manager in 1126. Before it exits, it will update the thread count in 1124.

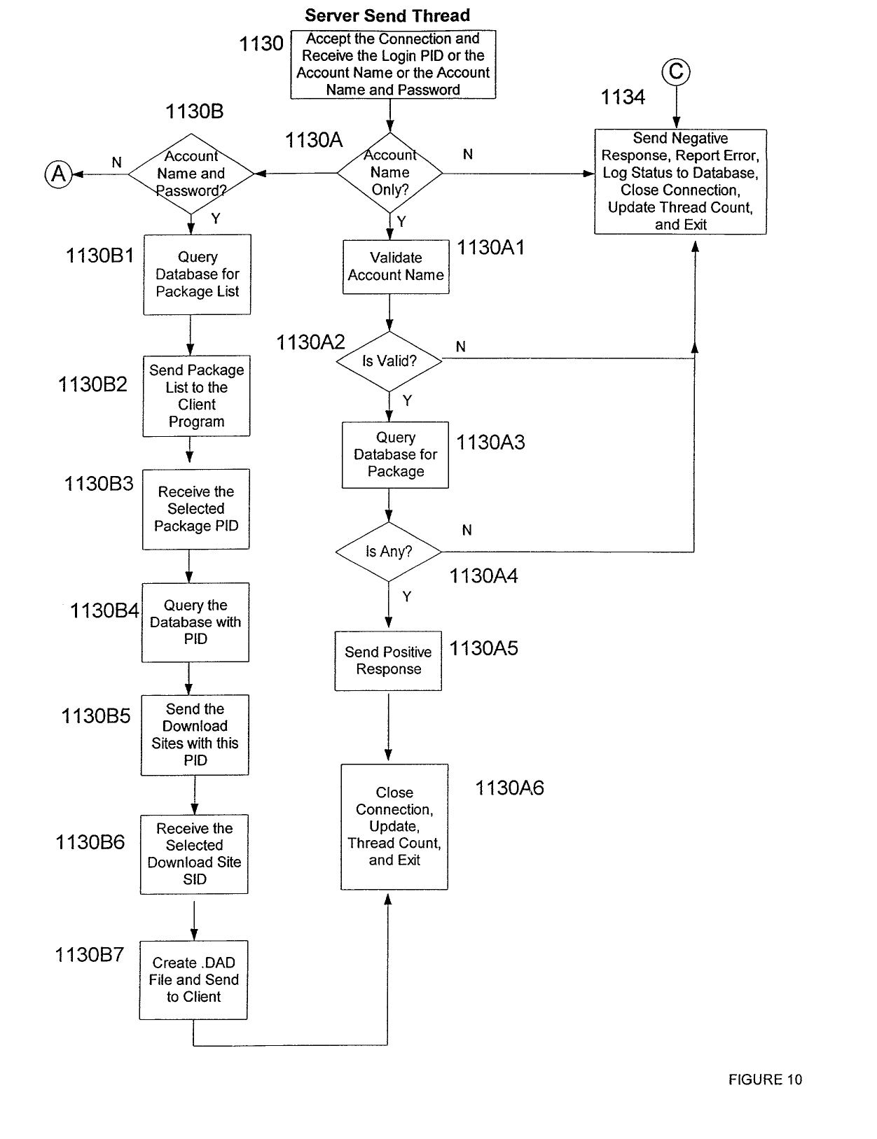

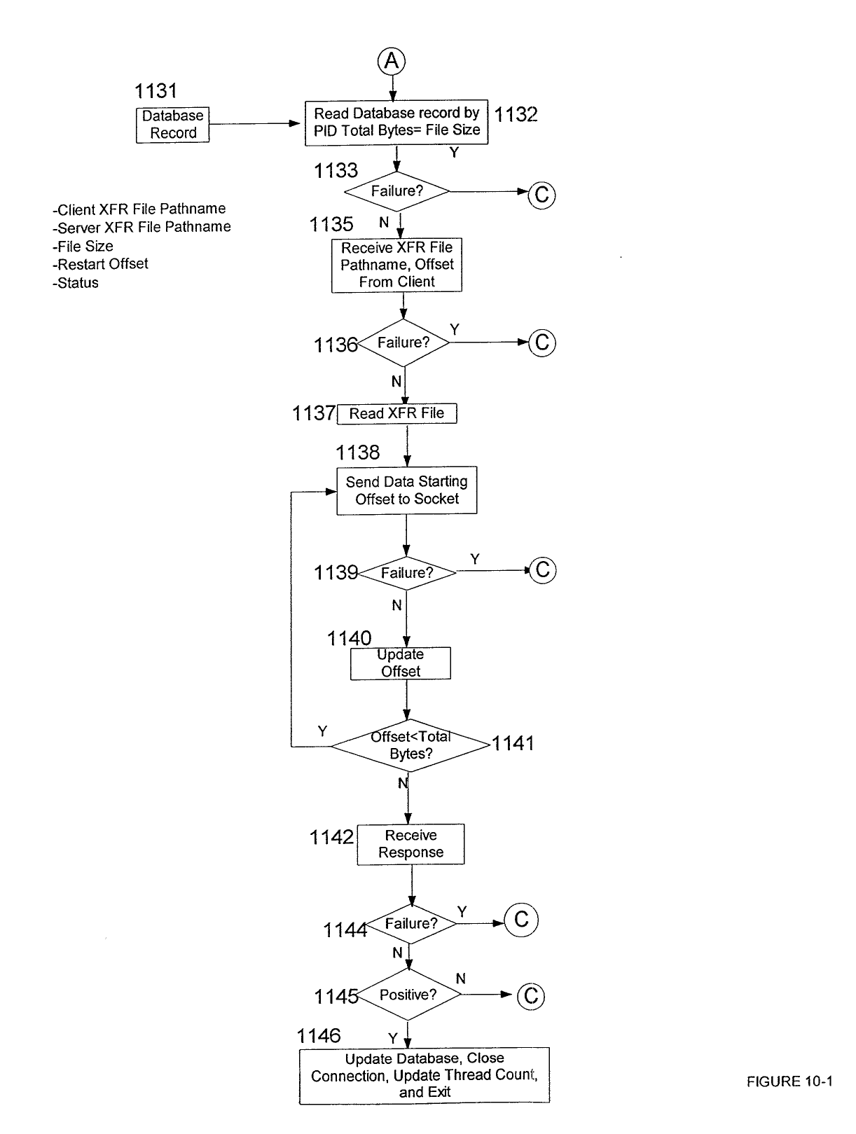

Referring now to FIG. 10, an exemplary process of sending a file to the client is described. There are three different types of requests from the sending port. The first one is the request from the recipient monitor program to check any package for the specified account (1130A). The second type of the request (1130B) is coming from the receive manager, which program interact with recipient and server program to get the recipient inputs. The third type of the request comes from the client receive program to download the specified file via web page or local displays.

The monitor program will try to connect to the send port of the server and login with the account name. Upon receiving the account name, the program validates it by querying database in 1130A1. If it is valid, it will query database to see any package for this account in 1130A3. If it has packages, the program will send a positive response to the client monitor program 11 30A5, close connection, update thread count, and exit.

The client receive manager will try to connect to the send port of the server and login with the account name and password. If the account name and password are valid, the program will query database for the package list in 1130B1. The result is then sent to the client receive manager in 1130B2. The program waits to receive PID from the client indicating the selected package in 1130B3. Based on the PID, the program will query the database in 1130B4 for the notify instructions and download sites list. The result will be sent to the client receive manager for the Recipient to choose the download site in 1130B5. When the SD indicating the download site is received in 1130B6, the program creates a .DAD file in 1130B7 and sends it to the client receive manager. Then, it closes the connection, updates thread count, and exits.

If the program receives the login ID, then it will get the package record 1131 from the database. If an error occurs in 1133, the ID is invalid or the database record can be retrieved. The program will report the error, log status to database, close connection, update thread count and exit as seen in 1134. In 1135 the program receives a message indicating the XFR file name and the starting offset of the transfer. The program will start to send data to socket starting at the file location indicated by the received offset in 1138. The process will be repeated until all data have been sent. It will wait to receive a positive response from the client in 1142 and update the database, close the connection, update the thread count, and exit in 1146.

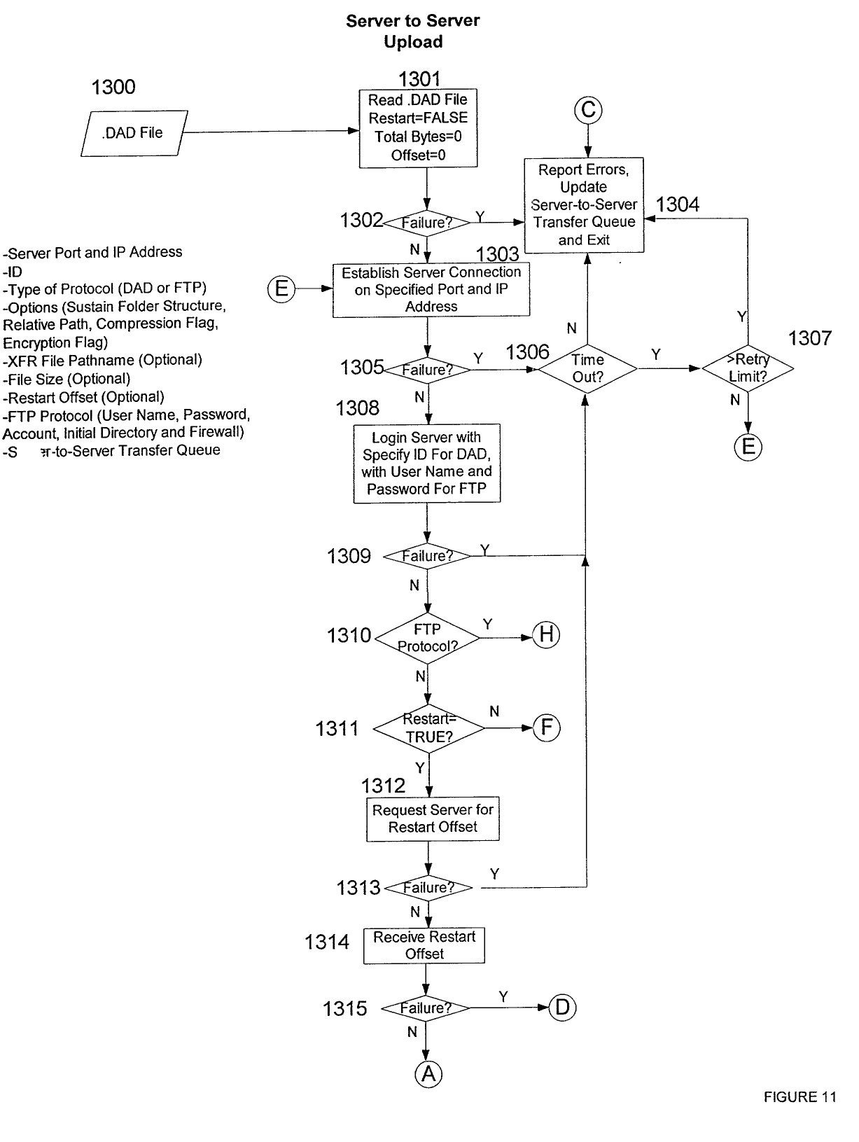

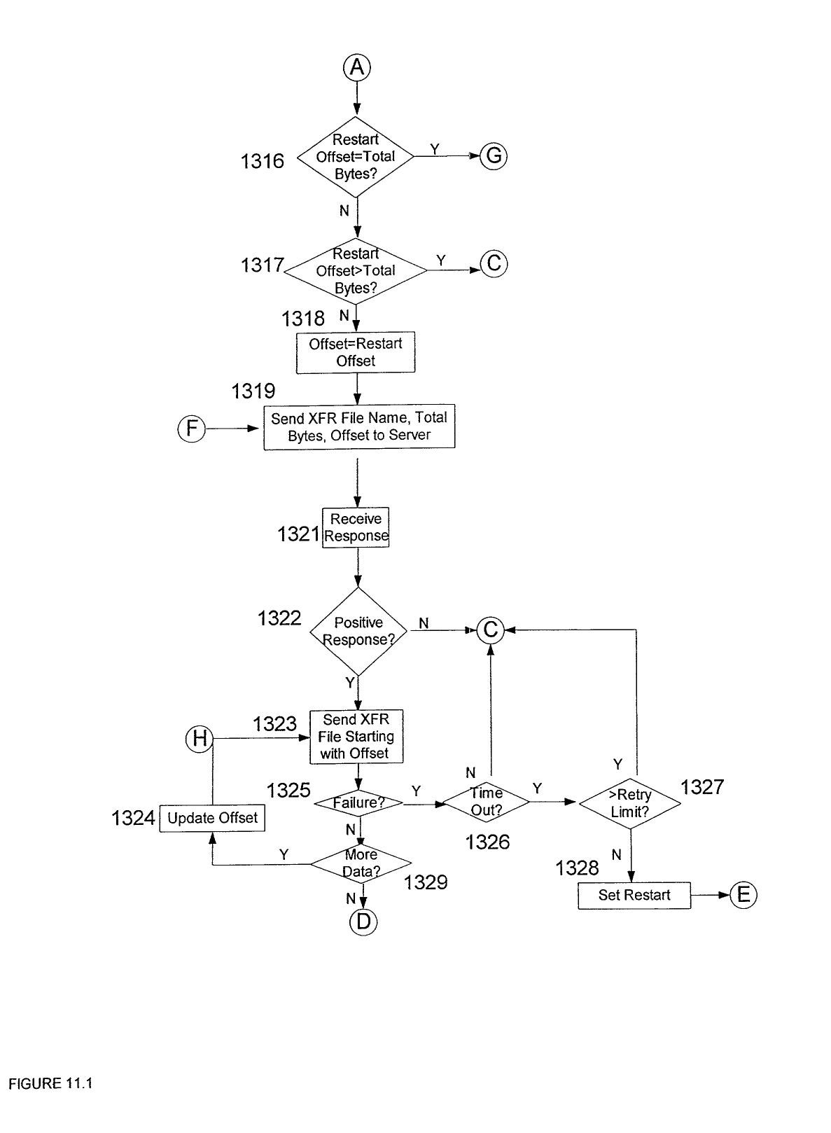

FIG. 11 illustrates an exemplary process of a server transferring file 20 and database record to another DAD server or transferring file to FTP server. In step 1300 the program reads .DAD file of 1300. The program establishes a connection with the other server using the port and IP address contained in the .DAD file in 1303. If the connection fails due to time out, a connection in 1303 may be performed again. In 1308, the program sends a login ID that is defined in the .DAD file to the other DAD server or sends User Name and Password for FTP login. For DAD-DAD transfer, both servers will use this ID to create or obtain the database record to facilitate the transfer and synchronize with each other. For DAD-FTP transfer, only file can be uploaded to the FTP server and without automatic restart.

For DAD-DAD transfer, if the upload program loses its connection with the DAD server when uploading the file, it will try to reconnect to the DAD server with the same ID for the restart. If it successfully logs in to the other DAD server, the upload program then needs to determine how much of the file has been reliably received on the DAD server. In 1015, the upload program sends a DAD protocol to the DAD server for restart offset. The DAD server receive program illustrated in FIG. 9 will check the file size and return the size as restart offset for the upload program to relocate the file pointer to the restart offset. If the total number of bytes reliably received by the DAD server indicates the previous transfer is completed in 1316, it proceeds to 1333 to complete the process. Otherwise the upload program will relocate the pointer to the restart offset in 1318. In 1319 the upload program sends the current XFR file name, file size, and the offset to the server to support resume operation.

The program sends the data to the socket in 1323. If the send to the socket command fails and indicates a time out error, the send program will automatically try to connect with server in 1303 for DAD-DAD transfer. The automatic restarts from step 1328 also may be limited in 1327, in number or in time, allowing automatic restart. If the XFR file has been sent successfully, the program waits for a positive response from the server, logs to database, updates queue, and exits.

FIG. 12 illustrates how the client monitor program uses an application protocol to communicate with the server program to monitor the package status. The server send port, IP address, and the account name are stored in the local permanent storage during the installation of the client program for the recipients. The monitor program uses the IP address and port to connect to the server in 1400. If it is connected, then the program will send the socket to the server the account name in 1403. If a positive response is received in 1405, there is a package on the server for the recipient. The program notifies the recipient using predefined multimedia method in 1407. If there is nothing for the recipient, the program waits a predefined time interval in 1402 and reconnects to the server. The multimedia notification will be delivered repeatedly to the recipient until the recipient activates the program in 1408. When the recipient activates the program via a command (e.g., a double click), the program will start the client receive manager in 1409 to interact with the recipient.

FIG. 13 illustrates how the client receive manager interacts with the recipient and communicates with the server program via an application protocol. The client receive manager uses the IP address and port to connect to the server in 1500. If it is connected, the program will prompt the recipient for the password in 1503. Then the program will send the password along with the account name to the socket for the server in 1504. After the account name and password are validated, the program receives and displays the list of the packages for the recipients in 1506. In 1507, the chosen PID is sent to the socket for the server. In 1508, the instructions along with the list of the available download sites are received and displayed by the receive manager. After the download site is chosen, the SID is sent to the socket for the server. A .DAD file, which is created by the server and includes the data required by the client receive program, is received and saved on the local machine in 1510. The program then launches the receive program with DAD file to download 15 the selected file from the chosen download site in 1511.

Thus, having presented the present invention in view of the above described embodiments, various alterations, modifications and improvements are intended to be within the scope and spirit of the invention. The foregoing description is by way of example only and is not intended as limiting. The invention's limit is defined only in the following claims and the equivalents thereto.

What is claimed is:

1. A method of securely transferring a file from a first client to a second client comprising issuing instructions from said first client to a server for transferring a file from said server to said second client, wherein said first client issues said instructions via a website for accessing said server.

2. The method according to claim 1, wherein prior to issuing said instructions, said method includes issuing initial instructions for uploading said file from said first client to said server and wherein upon said first client initially accessing said website, first embedded client software for uploading said file is automatically downloaded to said first client.

3. The method according to claim 2, wherein said initial instructions are issued if said file does not exist on said server.

4. The method according to claim 1, further comprising issuing second instructions to for notifying said second client that said file is available for downloading from said server.

5. The method according to claim 4, wherein said second instructions are forwarded to said server via a third client.

6. The method according to claim 5, wherein said third client comprises any one of a desktop computer, a laptop computer, a phone, and a wireless device.

7. The method according to claim 4, wherein said notifying comprises at least one of a visual indicator, a audio indicator, and/or an email message.

8. The method according to claim 4, further comprising downloading said file to said second client.

9. The method according to claim 8, further comprising automatically downloading second embedded client software upon said second client initially accessing said website.

10. The method according to claim 1, further comprising issuing second instructions for transferring said file to a second server.

11. The method according to claim 1, wherein either or both of said first client and said second client comprises a computer.

12. The method according to claim 1, wherein prior to issuing said instructions, said first client registers with said server website creating a first account for said first client.

13. The method according to claim 9, wherein prior to said second client initially accessing said website, said second client registers with said website creating a second account for said second client.

14. The method according to claim 2, wherein said first client specifies a default file transfer interface.

15. The method according to claim 14, wherein said default file transfer interface comprises a network-based interface.

16. The method according to claim 14, wherein said default file transfer interface comprises a resident interface of said first client software.

17. The method according to claim 13, wherein said second client specifies a default file transfer interface.

18. The method according to claim 17, wherein said default file transfer interface comprises a network-based interface.

19. The method according to claim 17, wherein said default file transfer interface comprises a resident interface of said second client software.

20. The method according to claim 19, wherein said second client software monitors the status of said second account to determine if a file is available for downloading from said server.

21. The method according to claim 20, wherein said second client software indicates that a file is available for transfer to said second client from said server.

22. The method according to claim 21, wherein said second client software indicates by at least one of a visual indicator, an audio indicator, a vibratory indicator, and/or an email message.

23. The method according to claim 2, wherein said first client software includes file compression, archiving and/or packaging utilities.

24. The method according to claim 9, wherein said second client software includes file decompression, restoring and/or installing utilities.

25. The method according to claim 1, wherein communications between said first client and said server and/or between said second client and said server and/or between said server and a second server are encrypted.

26. The method according to claim 1, wherein software resident in said server logs said issued instructions for transferring said file into a database.

27. The method according to claim 1, wherein said file is transferred from said first client to said server and/or from said server to said second client and/or from said server to a second server via TCP/IP protocol.

28. The method according to claim 22, wherein said email message includes a first link to a webpage of said server.

29. The method according to claim 28, wherein said webpage includes a second link to a second webpage for downloading said file.

30. The method according to claim 28, wherein said second webpage includes a return link for uploading said downloaded file to said server.

31. The method according to claim 28, wherein said second webpage includes a return link for returning said downloaded file to said first client.

32. The method according to claim 1, wherein software resident on said server tracks said file transfer.

33. The method according to claim 26, wherein said database includes at least one of account information, file package information, second client addresses, server site information, server list information, upload information and download information.

34. The method according to claim 26, wherein said first client may display and/or query said database for information related to specific file transfers.

35. The method according to claim 26, wherein information related to file transfers are recorded and stored in said database via a file identification of said file.

36. The method according to claim 35, wherein said file identification comprises at least one of a first client identification, a second client identification, file package information, a server site identification, and a download identification.

37. The method according to claim 2, wherein uploading said file may be interrupted and resumed.

38. The method according to claim 8, wherein downloading said file may be interrupted and resumed.

39. The method according claim 8, wherein downloading said file from said server may be interrupted, and wherein resumption of downloading said file may be carried out on a second server.

40. A method of transferring a file from a first client to a second client comprising:
issuing first instructions from said first client to register an account with a server via a website for transferring a file said second client, wherein said first client includes a web browser for accessing said website;
issuing second instructions for uploading said file to said server via said website and wherein upon said first client initially accessing said website, embedded client software for uploading said file is automatically downloaded to said first client;
notifying said second client that said file is available for downloading from said website;
connecting said second client to said server via said website for downloading said file, wherein said second client includes a web browser for accessing said website; and
downloading said file.

41. The method according to claim 40, wherein subsequent access to said server by said first client is through an interface of said client software.

42. The method according to claim 40, wherein upon said second client initially accessing said website, embedded second client software for downloading said file is automatically downloaded to said second client.

43. The method according to claim 42, wherein subsequent access to said server by said second client is through an interface of said second client software.

44. Computer readable media having stored thereon a data structure comprising:
a first field comprising data representing account information of a client;
a second field comprising data representing package information regarding a file for transfer;
a third field comprising address information for an address to transfer a file;
a fourth field comprising a server site;
a fifth field comprising a server list; and
a sixth field comprising download and/or upload information of a file.

45. A graphical user interface for a first client computer system having a selection device, said graphical user interface comprising:
a user login component for logging a client onto a website for a server;
a client browsing component for browsing the internet;
a file transfer component for forwarding a file to a second client;
a tracking component for retrieving tracking information for tracking said file forwarded to said second client;
an address book component storing and retrieving an address of said second client; and
an account information component for retrieving account information related to said first client and/or said second client.

46. A system for performing a method of transferring a file from a first client to a second client comprising:
a server accessible over the internet via a website, said server including communication means for communicating data with a client over the internet
a first client for instructing said server to forward a file to a destination address;
a second client having said destination address, wherein:
said first client issues first instructions for registering an account with said server via said website for transferring a file to said destination address of said second client, wherein said first client includes a web browser for accessing said website;
said first client issues second instructions for uploading said file to said server via said website and wherein upon said first client initially accessing said website, embedded client software stored on said server operational for a client to upload said file is automatically downloaded to said first client; and
said first client uploads said file to said server;
notifying means for notifying said second client that said file is available for downloading from said server, wherein:
said second client issues third instructions to said server via said website for downloading said file, wherein said second client includes a web browser for accessing said website; and
said second client downloads said file.

47. The system according to claim 46, wherein upon said second client initially accessing said website, client software stored on said server operational for a client to download said file is automatically downloaded to said second client.

48. Computer readable media having computer-executable instructions for performing a method comprising:
issuing first instructions from said first client to register an account with a server via a website for transferring a file to said second client, wherein said first client includes a web browser for accessing said website;
issuing second instructions for uploading said file to said server via said website and wherein upon said first client initially accessing said website, client software for uploading said file is automatically downloaded to said first client;
notifying said second client that said file is available for downloading from said web site;
issuing third instructions from said second client for downloading said file, wherein said second client includes a web browser for accessing said website; and
downloading said file.

49. The computer readable media according to claim 48, wherein upon said second client initially accessing said website, client software for downloading said file is automatically downloaded to said second client.
